(19) United States
(12) Patent Application Publication
(10) Pub. No.: US 2026/0289695 A1
(43) Pub. Date: Sep. 24, 2026

(54) COMPUTER-IMPLEMENTED METHODS AND SYSTEMS FOR GENERATING AND MANAGING MENU AND KITCHEN-RELATED DATA

(71) Applicant: Galley Solutions, Inc., Canyon Country, CA (US)

(72) Inventor: Benji Koltai, Canyon County, CA (US)

(73) Assignee: Galley Solutions, Inc., Canyon Country, CA (US)

(21) Appl. No.: 19/088,781

(22) Filed: Mar. 24, 2025

(51) Int. Cl. G06Q 50/12; G06F 9/451

(52) U.S. Cl. CPC G06Q 50/12; G06F 9/451

(57) ABSTRACT

A computer-implemented method for generating and managing menu and kitchen related data, including receiving ingredient selections from a user display of an ingredients computing module of a kitchen computing system, the ingredients computing module being in communication with an ingredients database and configured to read to and write from the ingredients database, the ingredients computing module configured to build the ingredients database of preparations that can be used to associate with ingredients managed by the ingredient computing module; and displaying a menu, using at least one or more recipes selections and a menu computing module of the kitchen computing system in communication with the recipes computing module and a menus database.

### BACKGROUND

Food preparation is a basic need. Meal planning becomes increasingly more complex as the quantity and variety of food prepared increases. To address the complexity, meal providers can (1) simplify their food offerings (e.g. menu) to reduce the variety of raw ingredients needed; and (2) order an excess of raw ingredients to compensate for any potential lack of raw ingredient inventory. As a result, as scale increases, quality of food offerings may decrease, and food waste may increase (thereby increasing food purchase cost). Computer-based tools can be used to some extent, however, to remain competitive while scaling up, meal providers laboriously track recipes, food inventory, and other logistics manually across separate tracking platforms.

The solution of this disclosure resolves these and other problems of the art.

### SUMMARY

A computing system that includes a user interface to modules and databases which kitchens and meal providers (referred to herein for simplicity as “kitchen”) can use to track day-to-day operations. The system can provide an interface to a menu database, a recipe database, an ingredients database, a preparations database, a vendor database, a purchase order database, an inventory database, or any combination thereof. Each database can be kitchen specific such that the respective database reflects offerings of the respective kitchen. Each kitchen may further have various locations. To accommodate the needs of such a kitchen, in some examples herein, items within each database can be associated with one or more of the locations such that certain menus, recipes, ingredients, preparations, vendors, purchase orders, and inventory items are location specific, i.e. only available at the associated locations.

Some or all of the databases can be accessed, at the user interface, via respective database modules which allow users associated with the kitchen to input and/or edit items in each respective database. With databases populated, the system can further provide, at the user interface, access to modules which allow the user to perform useful calculations, automate tasks, and/or generate work flows based on analysis of data across the kitchen-specific databases. Examples of such modules can include but are not limited to a food pricing module, a production guide module, an inventory restocking module, and a purchasing module.

The user interface is preferably web-browser based; however, the interface can be provided through additional and/or alternative means such as through an executable computer application, mobile user device application, and the like.

An example computing system including one or servers, the servers having one or more processors and non-transitory computer readable medium in communication with the processors and having instructions thereon that when executed by the processors, cause the computing system to provide a user interface and a plurality of computing modules. The computing modules can include an ingredients catalog module, a recipe catalog module, a menu planning module, and a costing module. The computing modules can further include a price module.

The ingredients catalog module can be in communication with an ingredients database. The ingredients catalog module can be configured to read to and write from the ingredients database.

The recipe catalog module can be in communication with the ingredients catalog module, a recipes database, and the user interface. The recipe catalog module can be configured to provide ingredient selection options to the user interface, receive ingredient selections from the user interface, generate a recipe based at least in part on the ingredient selections, and write the recipe to the recipes database.

The menu planning module can be in communication with the recipe catalog module and a menus database. The menu planning module can be configured to provide recipe options to the user interface, receive recipe selections and a recipe quantity for each recipe selection from the user interface, generate a menu based at least in part on the recipe selections, and write the menu to the menus database.

The costing module can be in communication with the menu planning module. The costing module can be configured to estimate a head count based at least in part on the recipe selections and the recipe quantity for each recipe selection and calculate a menu cost per head.

The menu planning module can further be configured to receive the recipe quantity for at least one of the recipe selections in a unit volume and/or unit weight. The costing module can further be configured to estimate a cost per head for the at least one of the recipe selections based at least in part on the unit volume and/or unit weight. The unit of volume and/or unit of weight can be a non-standard, user-defined unit. The costing module can further be configured to receive, from the user input, a unit name and a unit conversion of the non-standard, user-defined unit. The unit conversion can include a mathematical expression relating the non-standard, user-defined unit to a standard unit of measurement. The standard unit of measurement can be a standard unit of weight or a standard unit of volume.

The price module can be in communication with a vendor item database and the costing module. The price module can be configured to provide a cost per vendor item in the vendor item database to the costing module. The costing module can further be configured to receive the menu from the menu planning module, determine a cost per quantity of each ingredient selection of each recipe selection in the menu based at least in part on the cost per vendor item of vendor items in the vendor item database, and calculate the menu cost per head based at least in part on the cost per quantity of each ingredient selection of each recipe selection the menu.

An example method for managing a menu via a user interface can include one or more of the following steps executed in a variety of orders and additional steps as understood by a person of ordinary skill in the art according to the teachings herein. Ingredient selection options can be provided to the user interface. Ingredient selections can be received from the user interface. A recipe can be displayed, the recipe being based at least in part on the ingredient selections. Recipe selection options can be provided to the user interface. Recipe selections and a recipe quantity for each recipe selection can be received from the user interface. A menu can be displayed, the menu being based at least in part on the recipe selections. A calculated head count can be displayed without requiring a user input head count associated with a menu, the calculated head count being associated with the menu and being based at least in part on the recipe selections and the recipe quantity for each recipe selection. A calculated a menu cost per head count can be displayed.

Another example computing system can include an ingredients catalog module, a purchase order receiving module, and an inventory module. The computing system can further include a menu planning module and a purchasing module. The computing system can further include one or servers. The servers can include one or more processors and non-transitory computer readable medium in communication with the processors. The non-transitory computer readable medium can include instructions thereon that when executed by the processors cause computing system to provide the user interface and a plurality of computing modules. The computing modules can include the ingredients catalog module, the purchase order receiving module, and the inventory module. The computing modules can further include the menu planning module and the purchasing module.

The ingredients catalog module can be in communication with an ingredients database. The ingredients catalog module can be configured to read to and write from the ingredients database.

The purchase order receiving module can be configured to generate a list of vendor items received based on a finalized purchase order.

The inventory module can be in communication with the purchase order receiving module and an inventory database. The inventory module being can be configured to receive the list of vendor items, associate each vendor item in the list of vendor items with an ingredient in the ingredients database, associate each inventory item in the inventory database with an ingredient in the ingredients database, and update quantities of inventory items in the inventory database that are associated with ingredients also associated with vendor items in the list of vendor items. The quantities of inventory items include quantities per unit of volume and/or weight.

The menu planning module can be configured to provide a menu including a list of ingredients and an event date. The purchasing module can be in communication with the inventory module and the menu planning module. The purchasing module can be configured to compare the list of ingredients and quantities of said ingredients in the inventory item database and generate a purchase order based at least in part on the comparison.

### BRIEF DESCRIPTION OF THE DRAWINGS

FIG. 1 is a block diagram illustrating interactivity of modules within a computing system according to aspects of the present disclosure.

FIG. 2 is an illustration of an example dashboard page of a user interface to the computing system according to aspects of the present disclosure.

FIG. 3A is an illustration of an example menus browser page of the user interface to the computing system according to aspects of the present disclosure.

FIG. 3B is an illustration of the example menu browser page of FIG. 3A with selected menus according to aspects of the present disclosure.

FIG. 4 is an illustration of an example menu creation page of the user interface to the computing system according to aspects of the present disclosure.

FIGS. 5A and 5B are illustrations of an example menu page of the user interface to the computing system according to aspects of the present disclosure.

FIG. 5C is an illustration of a recipe table and ingredients cost calculation being updated on the menu page of FIGS. 5A and 5B according to aspects of the present disclosure.

FIG. 6A is an illustration of an example recipe browser page of the user interface to the computing system according to aspects of the present disclosure.

FIG. 6B is an illustration of the example recipe browser page with recipes selected according to aspects of the present disclosure.

FIG. 7 is an illustration of an example recipe creation page of the user interface to the computing system according to aspects of the present disclosure.

FIGS. 8A through 8E are illustrations of an example recipe page of the user interface to the computing system according to aspects of the present disclosure.

FIG. 9 is an illustration of an example pop-up window displaying a comparison of two versions of a recipe according to aspects of the present disclosure.

FIG. 10 is an illustration of an example ingredients browser page of the user interface to the computing system according to aspects of the present disclosure.

FIG. 11 is an illustration of an example new ingredient page of the user interface to the computing system according to aspects of the present disclosure.

FIG. 12 is an illustration of an example bulk ingredients page of the user interface to the computing system according to aspects of the present disclosure.

FIGS. 13A through 13D are illustrations of an example ingredient page of the user interface to the computing system according to aspects of the present disclosure.

FIG. 14 is an illustration of an example preparations browser page of the user interface to the computing system according to aspects of the present disclosure.

FIG. 15 is an illustration of an example preparation page of the user interface to the computing system according to aspects of the present disclosure.

FIG. 16 is an illustration of an example categories browser page of the user interface to the computing system according to aspects of the present disclosure.

FIG. 17 is an illustration of an example category page of the user interface to the computing system according to aspects of the present disclosure.

FIG. 18 is an illustration of an example vendor browser page of the user interface to the computing system according to aspects of the present disclosure.

FIGS. 19A and 19B are illustrations of an example vendor page of the user interface to the computing system according to aspects of the present disclosure.

FIG. 20 is an illustration of an example vendor item browser page of the user interface to the computing system according to aspects of the present disclosure.

FIG. 21 is an illustration of an example vendor group editing page of the user interface to the computing system according to aspects of the present disclosure.

FIG. 22 is an illustration of an example vendor item page of the user interface to the computing system according to aspects of the present disclosure.

FIG. 23 is an illustration of an example vendor group page of the user interface to the computing system according to aspects of the present disclosure.

FIG. 24 is an illustration of an example purchase orders browser page of the user interface to the computing system according to aspects of the present disclosure.

FIG. 25 is an illustration of an example purchase order page of the user interface to the computing system according to aspects of the present disclosure.

FIG. 26 is an illustration of an example location browser page of the user interface to the computing system according to aspects of the present disclosure.

FIG. 27 is an illustration of an example location page of the user interface to the computing system according to aspects of the present disclosure.

FIG. 28 is an illustration of an example location groups browser page of the user interface to the computing system according to aspects of the present disclosure.

FIG. 29 is an illustration of an example location group page of the user interface to the computing system according to aspects of the present disclosure.

FIG. 30 is an illustration of an example inventory record browser page of the user interface to the computing system according to aspects of the present disclosure.

FIG. 31 is an illustration of an example inventory record page of the user interface to the computing system according to aspects of the present disclosure.

FIG. 32 is an illustration of an example inventory item search pop-up window of the user interface to the computing system according to aspects of the present disclosure.

FIG. 33 is an illustration of an example inventory creation page populated based on ingredients in menus selected from the menus browser page of the user interface to the computing system according to aspects of the present disclosure.

FIGS. 34A and 34B are an illustration of an example purchasing page populated based on ingredients in menus selected from the menus browser page of the user interface to the computing system according to aspects of the present disclosure.

FIG. 35 is an illustration of an example production list page populated based on ingredients in menus selected from the menus browser page of the user interface to the computing system according to aspects of the present disclosure.

FIG. 36 is an illustration of an example server-based computing system according to aspects of the present disclosure.

### DETAILED DESCRIPTION

Meal planning becomes increasingly complex as the scale of services provided increases. Take, for instance the menu development stage where recipes are selected, and quantities of dishes are estimated. Executed in a vacuum, the task seems simple enough: select recipes and multiply the quantity accordingly to obtain the desired quantity of dishes. However, choices made during menu selection have consequences that propagate through the remainder of the food service process. At worst, a menu may not be feasible if food items and/or preparation resources are not available. At the least, costs associated with food items and preparation resources are impacted. Quality of prepared dishes can also be impacted if preparation is complex or if food preparers are not armed with proper tools and production guidance. As scale increases, without careful analysis during the menu development process, likelihood of inadvertently selecting an unavailable resource and inaccurately estimating dish quantity also increases. Menu option cost comparison also becomes increasingly complex and impactful as scale increases. Preparation logistics also become increasingly complex as scale increases. All of the above challenges affect cost and quality of dishes and services provided.

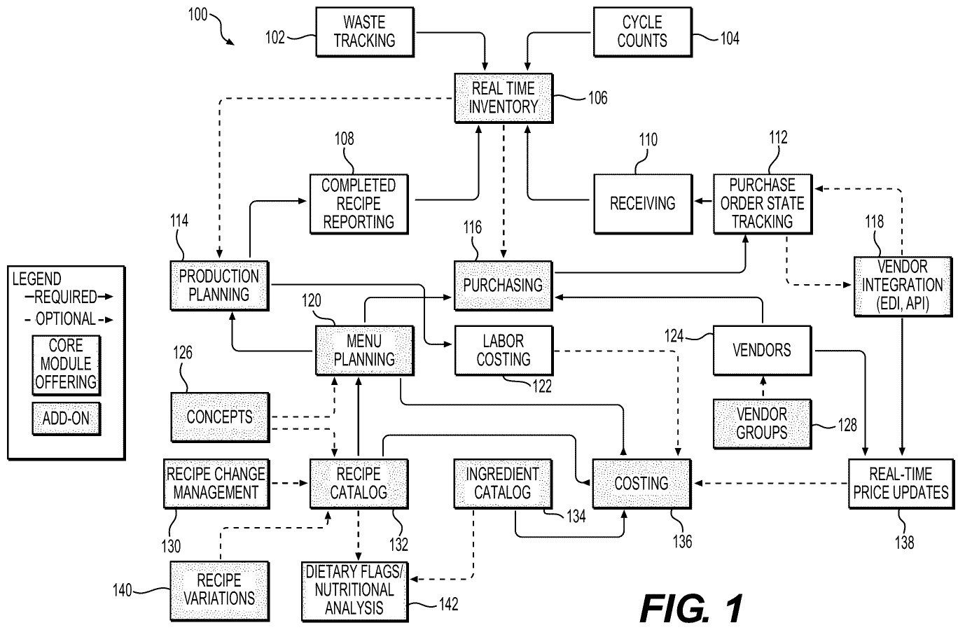

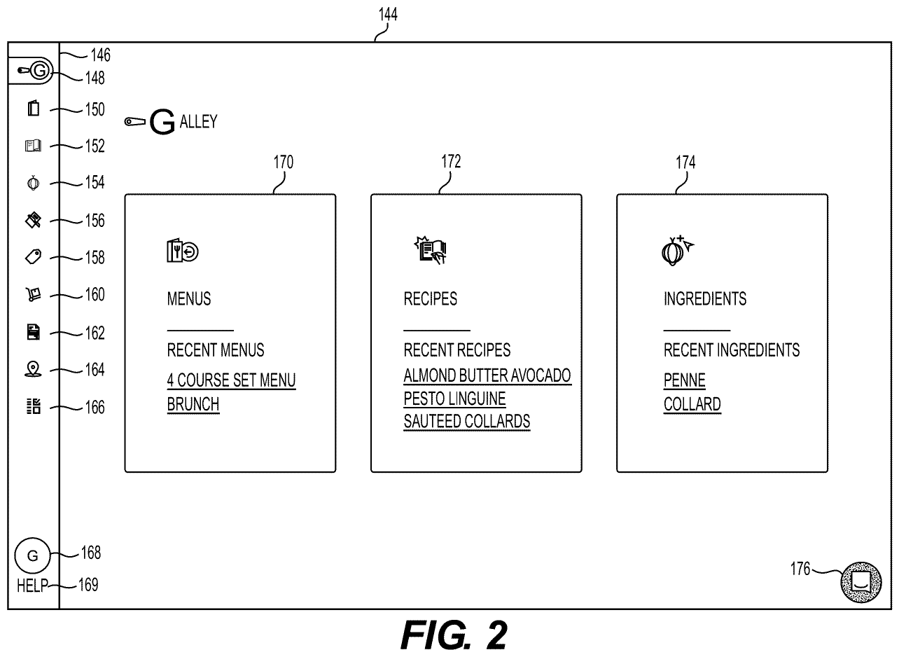

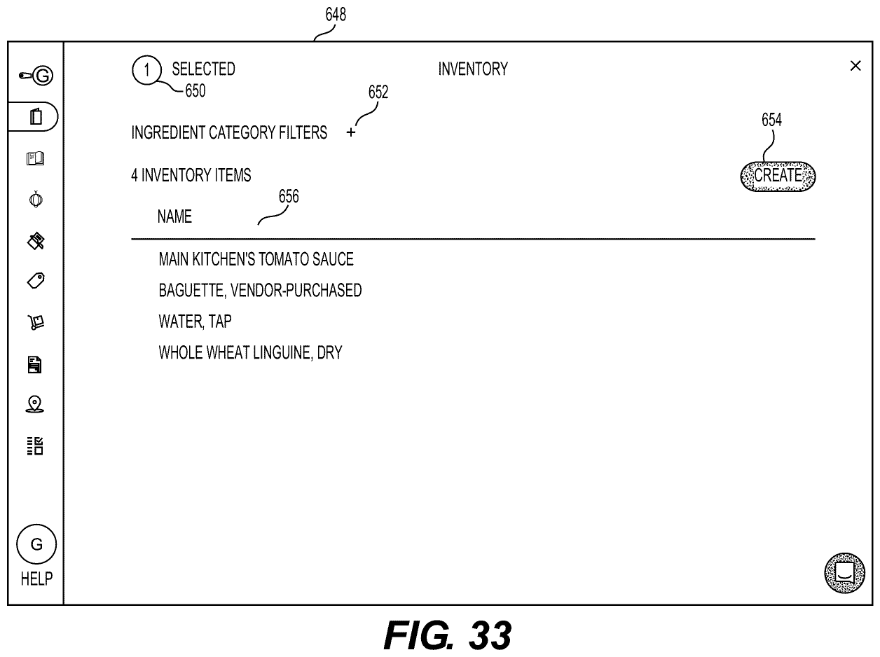

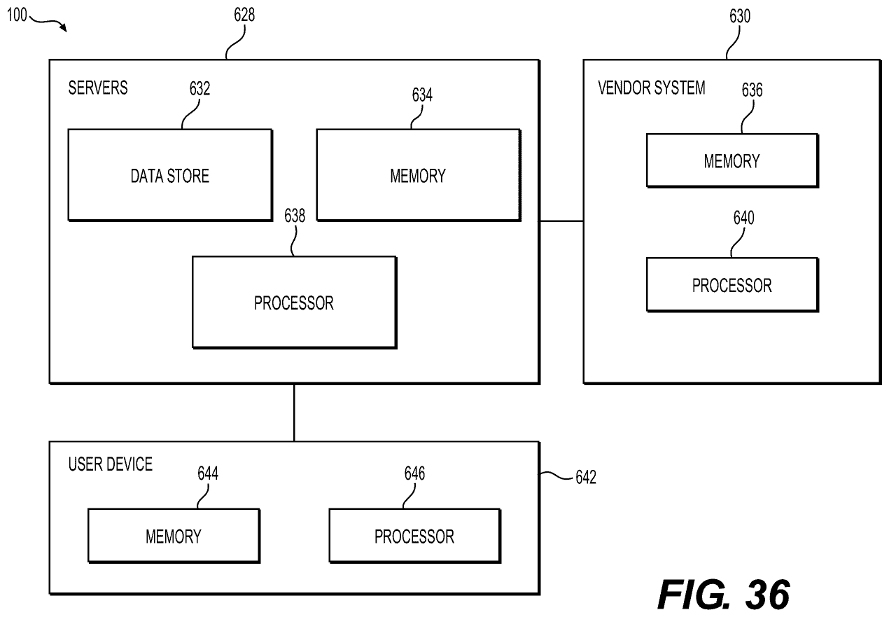

FIG. 1 is a block diagram illustrating architecture of an example computing system 100. The system 100 can enable kitchens to manage and/or automate tasks associated with providing a food service. The computing system 100 includes modules 102-142 and a user interface (see FIGS. 2 through 35). FIG. 36 is an illustration of an example computing system 100 including one or more servers 628 having one or more processors 638 and non-transitory computer readable medium 634 in communication with the processor(s). The non-transitory computer readable medium 634 can include instructions thereon, that when executed by the processor(s) 638 cause the system 100 to provide some or all of the modules 102-142 illustrated in FIG. 1. Some or all of the modules are in communication with databases which can store ingredient, recipe, menu, vendor, vendor item, kitchen inventory, other kitchen-related information, and any combination thereof. As illustrated in FIG. 33, the servers 628 can themselves include, or otherwise be in communication with a data store 632. The data store can include some or all of the aforementioned databases. Each database can be kitchen specific such that the respective database reflects offerings of the respective kitchen. Each kitchen may further have various locations. To accommodate the needs of such a kitchen, in some examples herein, items within each database can be associated with one or more of the locations such that certain menus, recipes, ingredients, preparations, vendors, purchase orders, and inventory items are location specific, i.e. only offered at the associated locations.

Some or all of the databases can be accessed, at the user interface, via respective modules which allow users associated with the kitchen to input and/or edit items in each respective database. With databases populated, the system can further provide, at the user interface, access to modules which allow the user to perform useful calculations, automate tasks, and/or generate work flows based on analysis of data across the kitchen-specific databases.

As illustrated in FIG. 33, the system 100 can include, and/or be in communication with, a user device 642. The user device 642 can include a processor 646 and memory 644. The memory 644 can include instructions thereon to run an application (e.g. web-browser or dedicated executable) to display the user interface and receive user input at the user interface. In some examples, in addition, or as an alternative to storing databases at the server data store 632, some or all databases can be stored locally on the memory 644 of the user device 642.

The system 100 can further include, and/or be in communication with, a vendor system 630. The vendor system 630 can include a processor 640 and memory 636. The memory 636 can include instructions thereon to run an application (e.g. web-browser or dedicated executable) to gather vendor item data such as cost and sellable vendor item quantities (e.g. crate, pack, etc.).

The computing system 100 is preferably provided as software as a service (SaaS) such that the system 100 is maintained by a service provider, and users are provided access to the system 100 illustrated in FIG. 1 via the user interface as illustrated in FIGS. 2 through 35 on a user device 642 as illustrated in FIG. 36. Databases (not illustrated) can be accessed by respective modules, either by virtue of being stored on memory at the service provider (e.g. in the server data store 632), at the user device (e.g. in device memory 644), or elsewhere (e.g. cloud). The system 100 can additionally, or alternatively be provided by other means, such as a traditional executable software on a user device, or other means as appreciated and understood by a person of ordinary skill in the art.

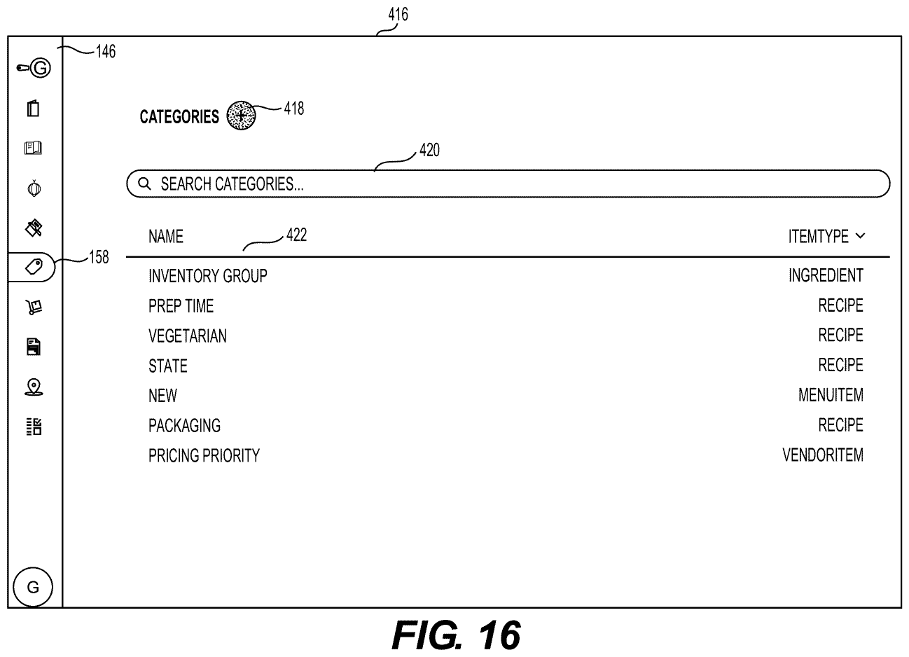

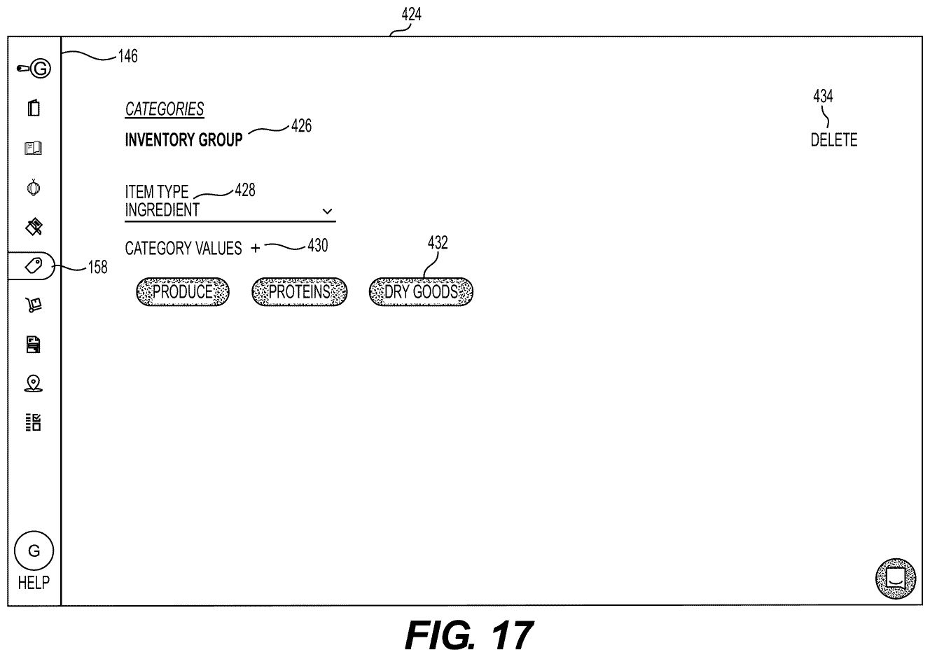

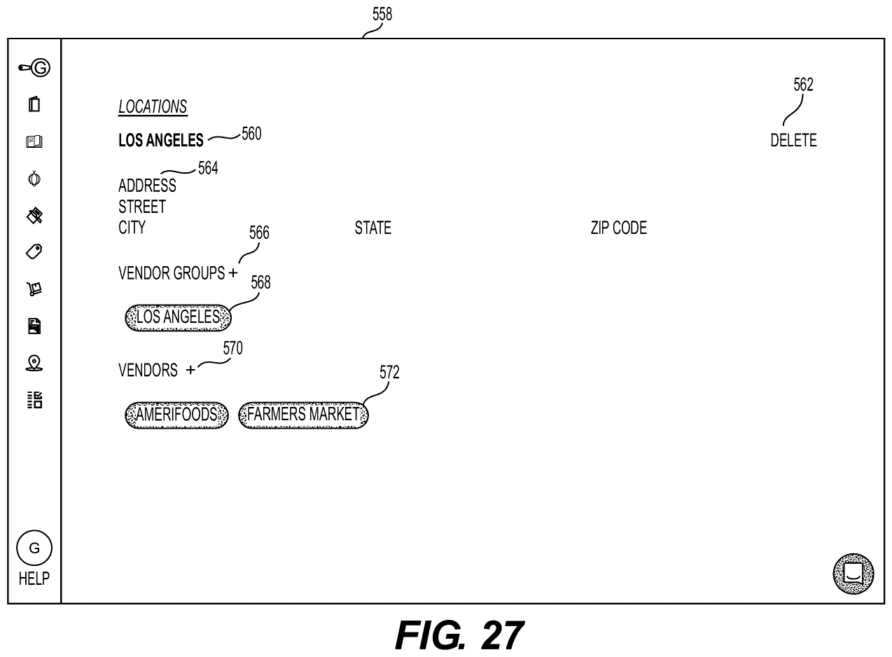

At a high level, each module 102-142 illustrated in FIG. 1 represents a step in the meal planning process. After only a brief review of FIG. 1, it becomes readily apparent that effective meal planning is not a linear process. To simplify the discussion, the process can be broken down into three groups of tasks including: tracking ingredients, building recipes, building menus, production planning, and purchasing. For a kitchen having multiple locations, each group of tasks can link processes to a specific location. FIGS. 27 through 29 illustrate pages of the user interface where the user can input locations. The user can further benefit from custom organization of ingredients, recipes, menus, etc. by creating custom categories for each group of tasks. FIGS. 16 and 17 illustrate pages of the user interface where the user can input custom categories.

### Ingredient Tracking

Tracking ingredients can include tracking the availability and cost of ingredients. For this purpose, the system 100 can include a real time inventory module 106, a vendor module 124, a real-time pricing update module 138, an ingredients catalog module 134, and a costing module 136.

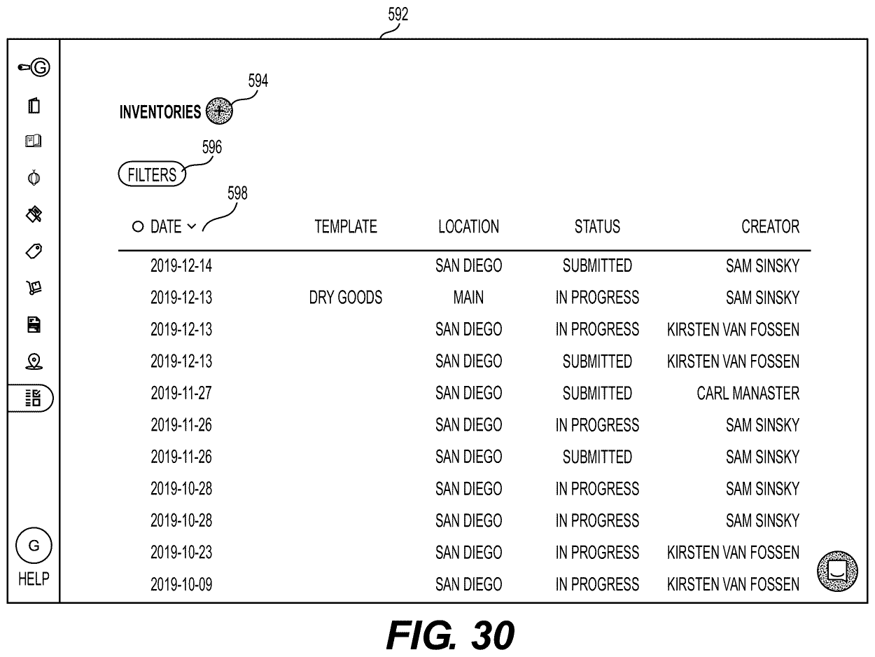

The real time inventory module 106 is configured to track ingredients that the kitchen has in stock. FIGS. 30 through 35 illustrate pages of the user interface where the user can input inventory data in the form of inventory reports. The user can create custom categories for sorting the inventory. For a kitchen having multiple locations, the real time inventory module 106 can track ingredients at each location. The real time inventory module 106 can be in communication with an inventory database (not shown) with tracked kitchen inventory. Each ingredient tracked in the inventory database can be associated with an ingredient maintained by the ingredient catalog module 134. The real time inventory module 106 can further update a database of kitchen inventory automatically based on data received from a waste tracking module 102, a cycle counts module 104, a completed recipe reporting module 108, and a receiving module 110.

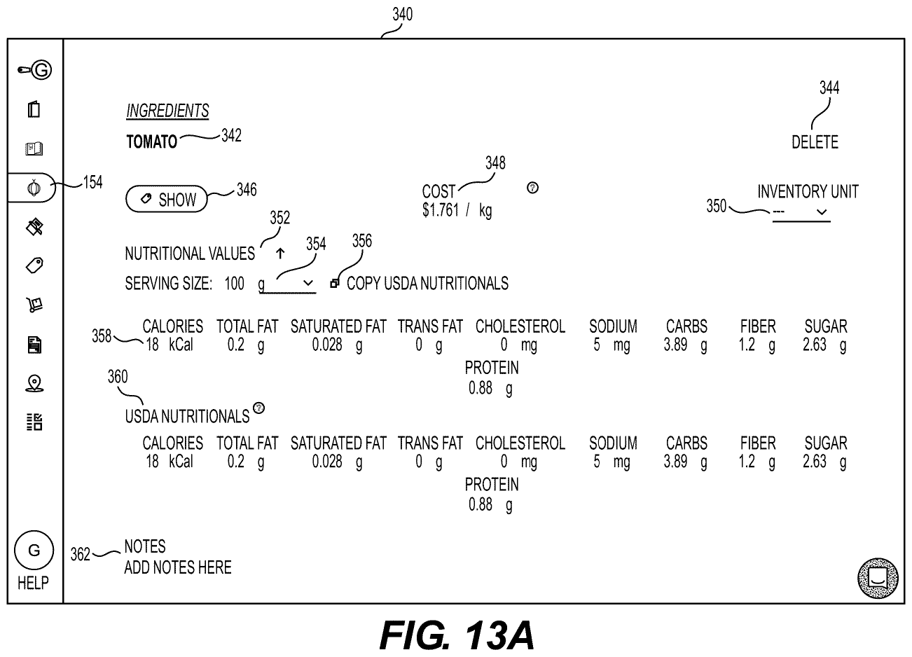

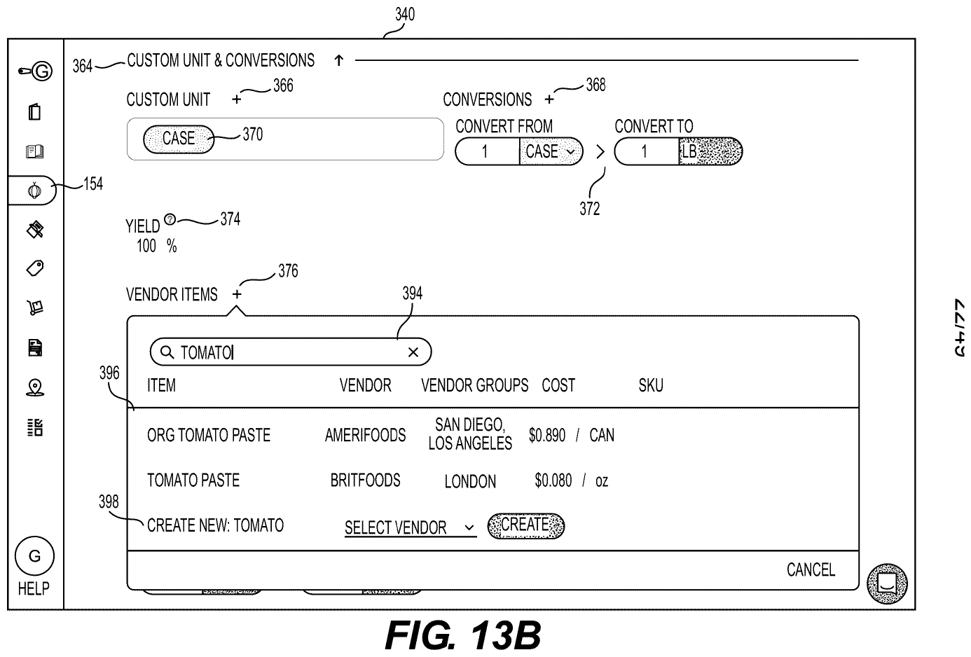

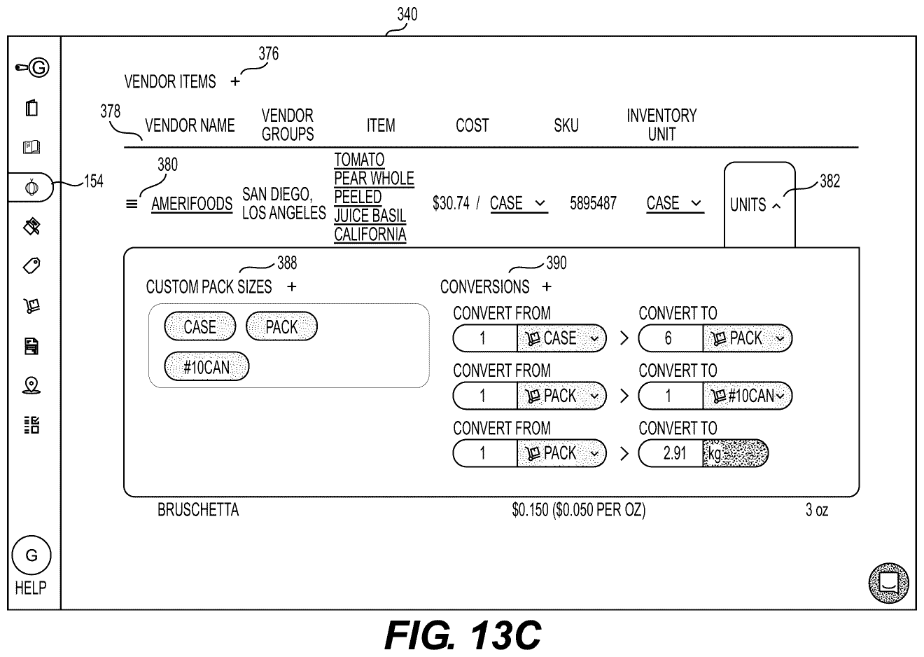

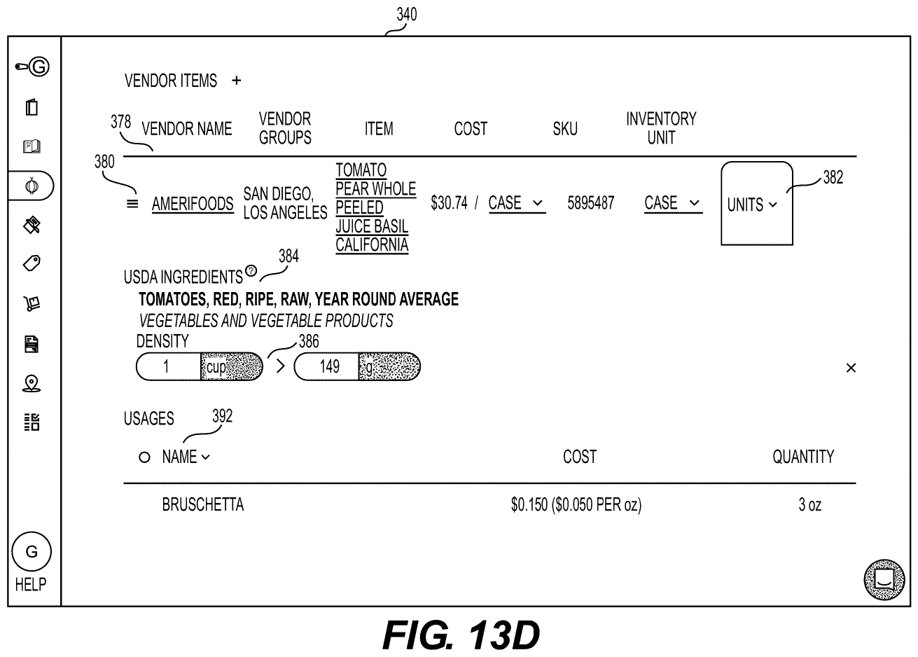

The waste tracking module 102 provides data related to waste. Each ingredient managed by the ingredient catalog module 134 can include an estimated quantity of trim waste. The trim waste (trim yield) is calculated as a percentage of the total quantity of the purchased ingredient that is removed from the food product and discarded (e.g. seeds, stems). Trim waste is used to calculate an “untrimmed” or “uncut” absolute quantity of an ingredient within the context of a recipe. In some examples, trim waste quantities can be preparation dependent, meaning the preparations included in a recipe for a given ingredient can be used to determine the trim waste of that ingredient for that recipe. The “untrimmed” or “uncut” quantities can be used to purchase correct quantities of the ingredient to ensure the trim waste is accounted for. Trim waste can be set by the user via the yield input 374 on the ingredients page 340 as illustrated in FIG. 13B. Additionally, or alternatively, trim waste can be calculated based on a starting quantity and an ending quantity of the ingredient, before and after the recipe is executed. In such an example, the starting and ending quantities can be input manually by the user, either directly or via inventory management (e.g. the system 100 estimates trim waste-based amount of ingredients received and amount of ingredients remaining in inventory after the recipe is executed.)

The receiving module 110 provides data related to vendor items delivered and received as a result of purchasing. The completed recipe reporting module 108 provides data related to use of vendor items when recipes are prepared as food items (e.g. cooked or otherwise prepared).

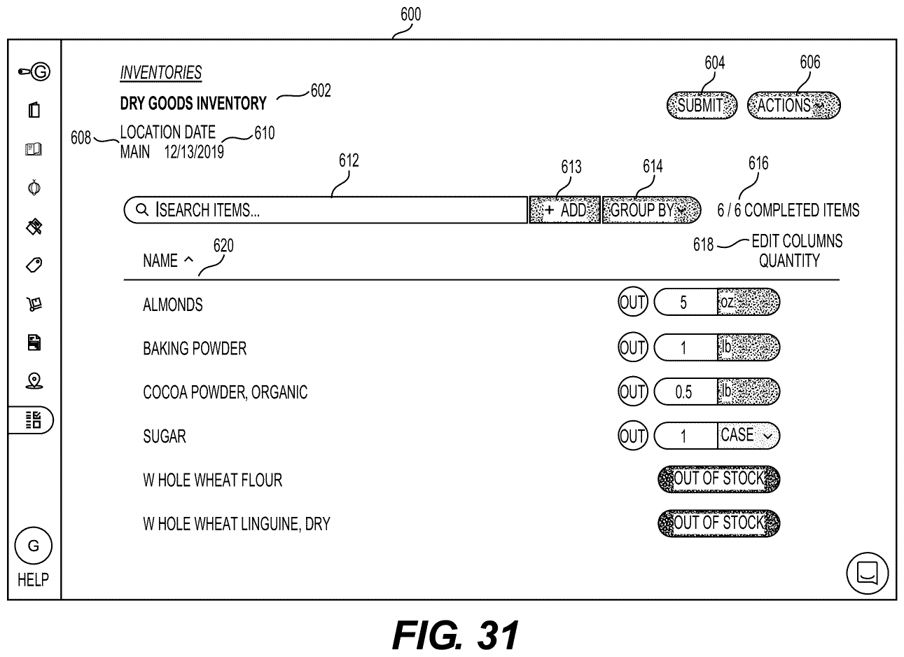

The cycle counts module 104 provides data related to inventory. The cycle counts module 104 can allow the user to provide a virtual audit of inventory. The cycle counts module 104 can produce an inventory list that is calculated based on inventory data intake received from the receiving module 110 and usage of ingredients when recipes are completed form the recipe module 108. In some examples, the cycle counts module 104 can further consider other forms of ingredient intake and usage such as wasting items, selling items, etc. The audit can be presented to the user via an inventory page such as illustrated in FIG. 31. The user can then edit the generated audit inventory manually if needed as described in relation to FIG. 31.

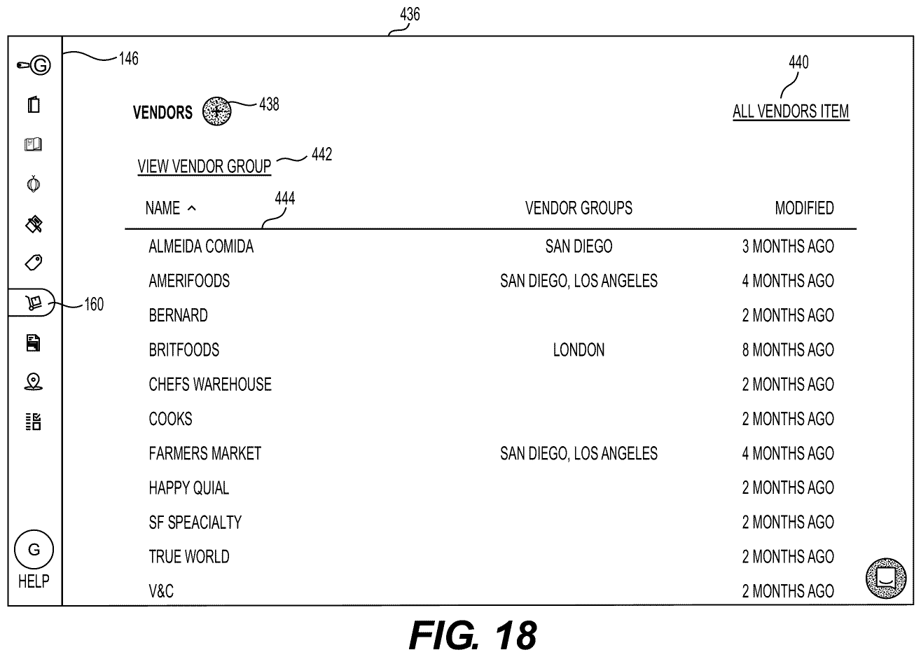

The vendors module 124 and real-time price update module 138 are configured to track vendors and vendor items that the kitchen can purchase. FIGS. 18 through 23 illustrate pages of the user interface where a user can enter vendor and vendor item data. For a kitchen having multiple locations, the vendors module 124 can be configured to associate vendors and/or groups of vendors with a subset of the locations. Vendor items can be associated with a location by virtue of being associated with a vendor that is associated with the location. A vendor groups module 128 can be in communication with the vendors module 124 to manage vendor groups. Each vendor item can be associated with one or more ingredients managed by the ingredient catalog 134. Cost of vendor items can be managed by the real-time price updates module 138. The real-time price updates module 138 can receive user provided vendor item price data from the vendors module 124 and/or vendor provided vendor item price data from a vendor integration module 118. The vendor integration module 118 can include a vendor-facing user interface such as an electronic data interchange (EDI), application programming interface (API), and/or other such interface.

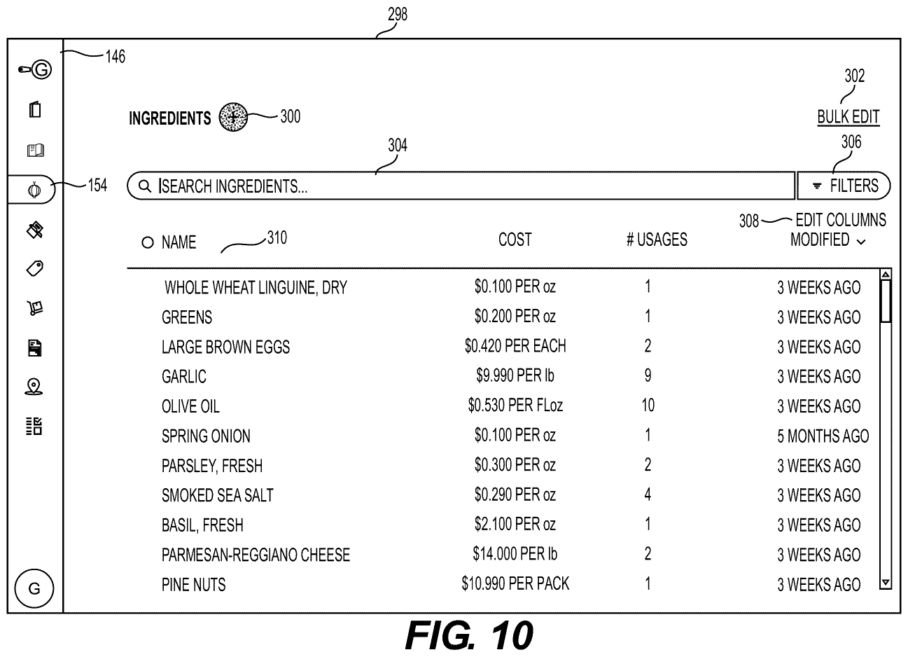

The ingredients catalog module 134 is configured to manage an ingredients database (not illustrated). FIGS. 10 through 12 and 13A through 13D illustrate pages of the user interface where the user can enter ingredient data. Each ingredient included in a recipe managed by the system 100 is managed by the ingredients catalog module 134. Ingredients can include eatable items and non-eatable items (e.g. napkins). Inventory managed by the real time inventory module 106 and vendor items managed by the real time price updates 138 and vendors 124 modules can be associated with ingredients managed by the ingredient catalog 134. The ingredients catalog module 134 can further be in communication with a dietary flags/nutritional analysis module 142 to further associate each ingredient maintained by the ingredients catalog module 134 with dietary and/or nutritional data.

The costing module 136 can receive data from the ingredient catalog module 134 and real-time price updates module 138. The costing module 136 is configured to calculate one or more costs associated with an ingredient based on vendor item association(s) with that ingredient. Costs of ingredients can be location specific by virtue of being associated with one or more vendor items that are respectively associated with a location. The costing module 136 can further manage custom unit conversions. A user can name an arbitrary unit of volume or weight of a given vendor item, ingredient, or recipe product and provide a conversion between the arbitrary unit and a known volume or weight. The known volume or weight can be a standard volume or weight (e.g. liter or gram) or another arbitrary unit of volume or weight that is ultimately linked to a standard volume or weight via a custom conversion. The costing module 136 can further maintain a density calculation for ingredients, vendor items, and/or recipe products that can be used to convert between units of volume and weight. The density calculation per ingredient can be based on publicly available data (e.g. USDA provided)

### Building Recipes

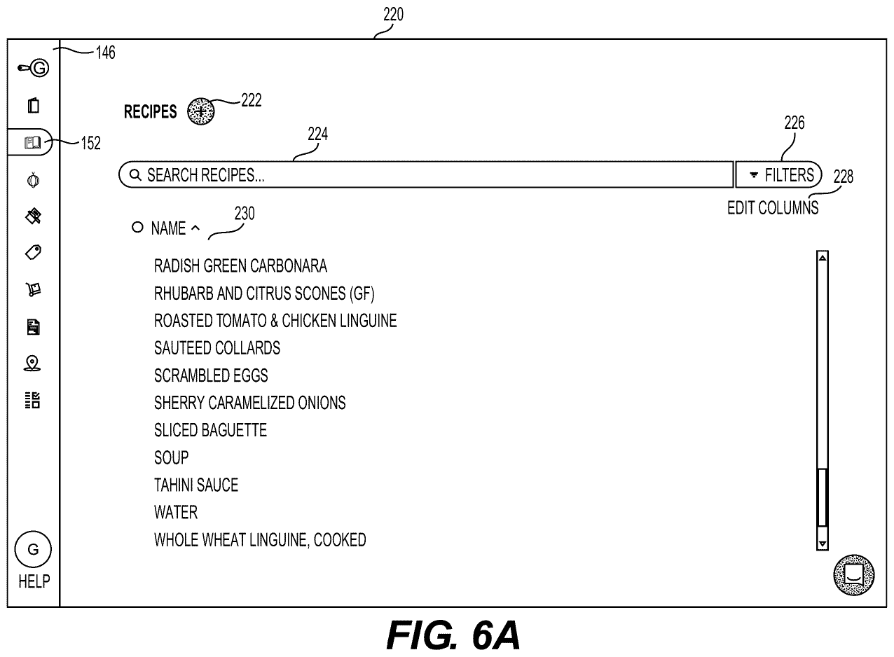

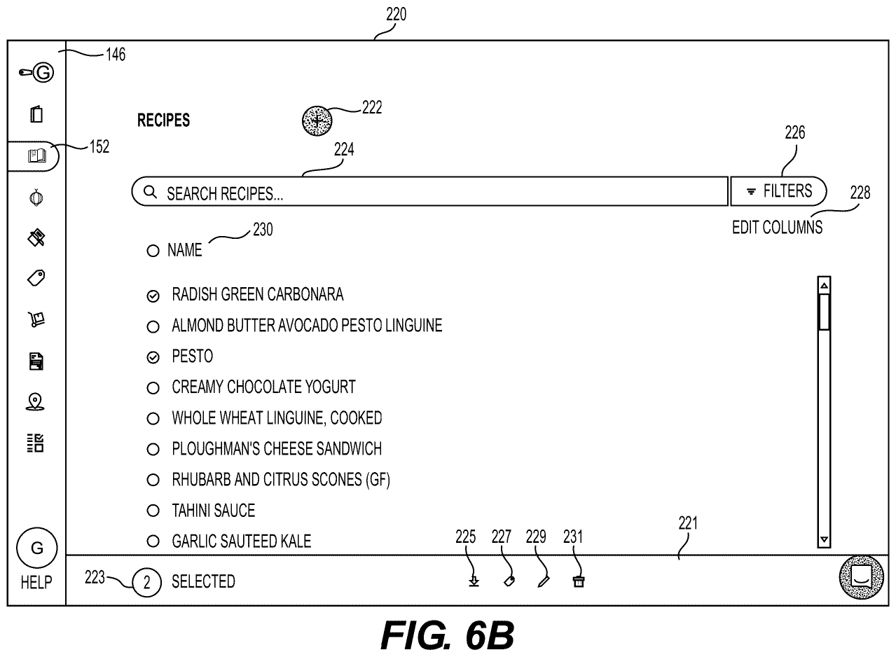

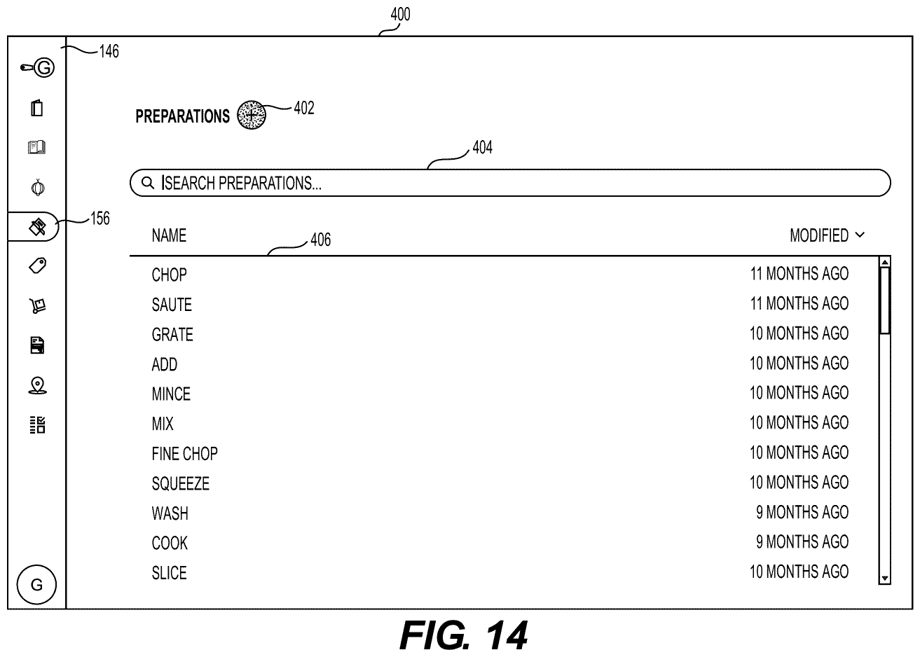

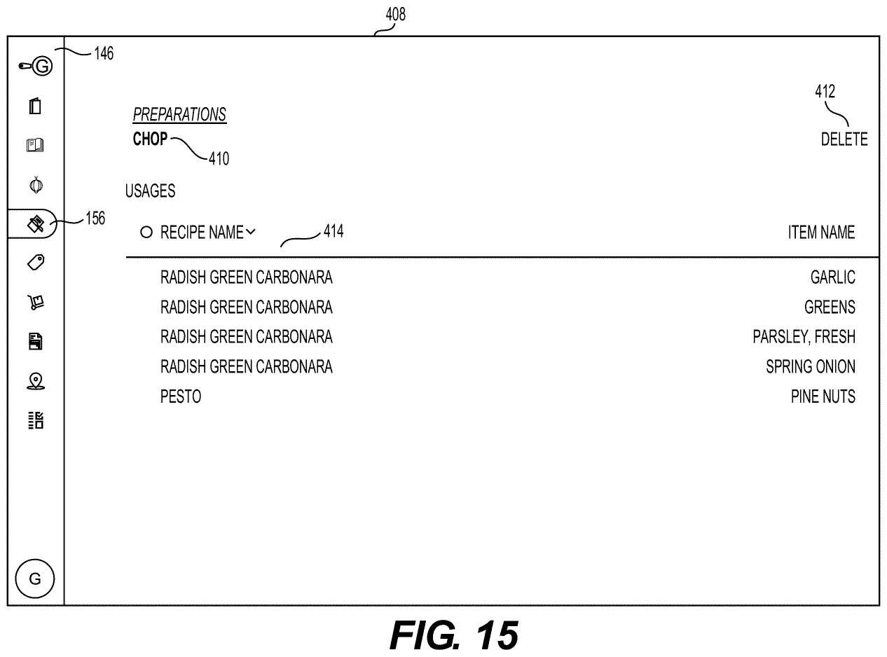

Building recipes can include assembling a list of ingredients, generating a list of process steps, and costing recipes. For this purpose, the system 100 can include a recipe catalog module 132. FIGS. 6 through 9 illustrate pages of the user interface where a user can build recipes. FIGS. 14 and 15 illustrate pages of the user interface where a user can build a database of preparations that can be used to associate process steps with ingredients managed by the ingredient catalog module 134.

The recipe catalog module 132 can be in communication with the ingredient catalog module 134, the costing module 136, a recipe variations module 140, a recipe change management module 130, a concepts module 126, and a dietary/nutritional analysis module 142. The recipe catalog module 132 can receive ingredient-related data from the ingredient catalog module 134.

Cost of recipes can be calculated by the costing module 136. For kitchens having multiple locations, each recipe and/or recipe variation can be associated with a location. Location-specific cost of each recipe can be calculated based each ingredients' association with a vendor item that is associated with that location. A user can name an arbitrary unit of volume or weight of a given recipe product and provide a conversion between the arbitrary unit and a known volume or weight. Further, quantities of ingredients used within the recipe can be expressed by an arbitrary unit of volume or weight and associated arbitrary conversion. The user can further provide a price (e.g. charged to a customer) for the produce produced by following the recipe. In such cases, the costing module 136 is configured to calculate a margin based on the cost and price of the product produced by the recipe.

Dietary and/or nutritional data for the food items prepared as a result of following the recipe can be calculated based on data managed by the dietary flags/nutritional analysis module 142. Recipes can be associated with variations managed by the recipe variations module 140. Changes to recipes can be tracked by the recipe change management module 130. The concepts module 126 can allow further categorization of recipes and menus into sub-groups that can represent internal groupings for a given company (kitchen).

### Building Menus

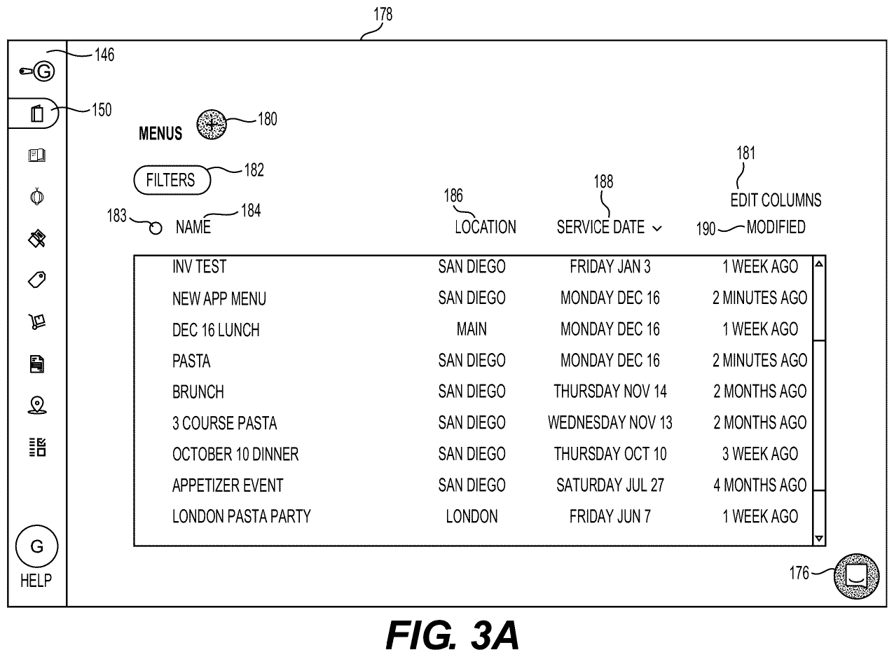

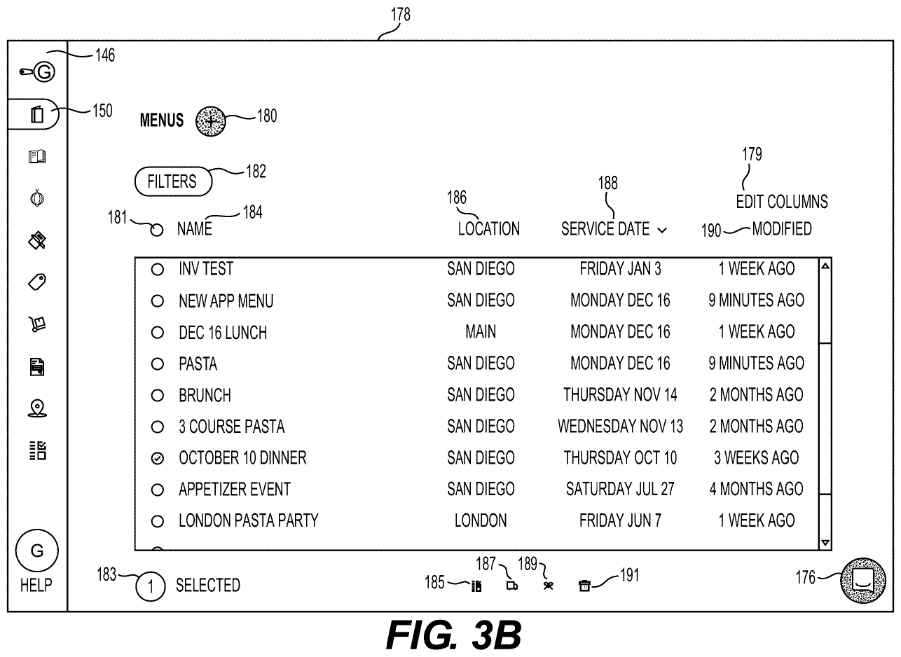

Building menus can include assembling recipes, calculating quantities of production of each recipe, and costing the menu. For this purpose, the system 100 can include a menu planning module 120. FIGS. 3, 4, and 5A through 5B illustrate pages of the user interface were a user can build menus.

The menu planning module can be in communication with the recipe catalog module 132, the costing module 136, and the concepts module 126. The menu planning module 120 can receive recipe related data from the recipe catalog module 132. Cost of each menu can be calculated by the costing module 136. Cost of menus can be calculated per head and/or per total volume. Cost of each quantity of recipe within the menu can be calculated based an arbitrary unit of volume or weight of the recipe product and an arbitrary conversion. The concepts module 126 can allow further categorization of recipes and menus into sub-groups that can represent internal groupings for a given company (kitchen). For instance, a given kitchen can provide multiple brands, each with their own delivery platform, in which case the concepts module 126 can allow the user to associate recipes and/or menus each with one or more of their brands.

### Production Planning

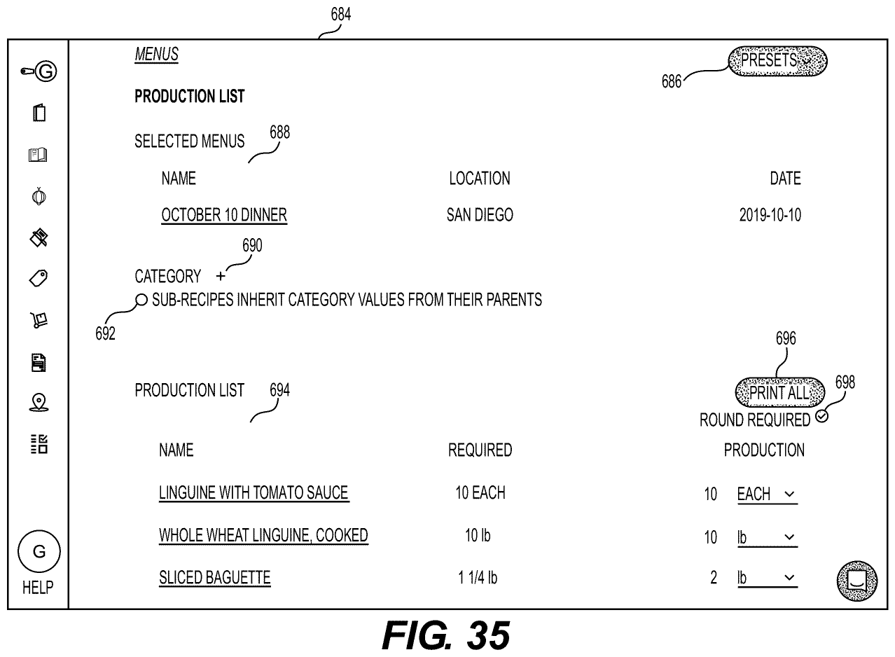

Production planning can include generating instructions for executing a menu. For this purpose, the system can include a production planning module 114. The production planning module 114 is accessible from the user interface via the production list page 684 illustrated in FIG. 35. A user can select menus from the menus browser page 178 as illustrated in FIG. 3B and click the production planning button 189. The production planning module 114 can then populate the production list page 684 illustrated in FIG. 35 based on the user's menu selections. The production planning module 114 manages the user inputs via the production list page 684 and provides a printable production plan output.

### Purchasing

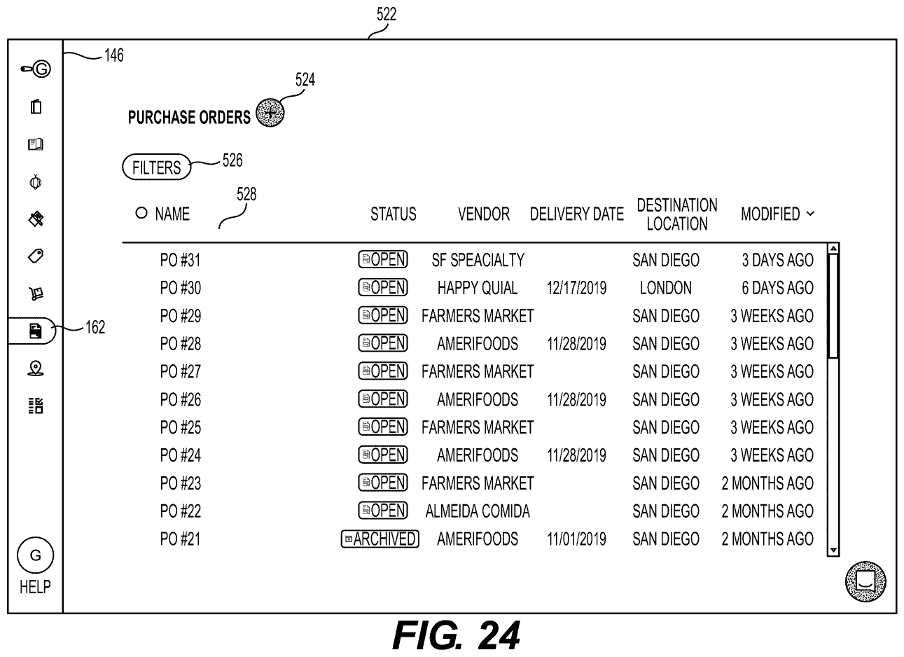

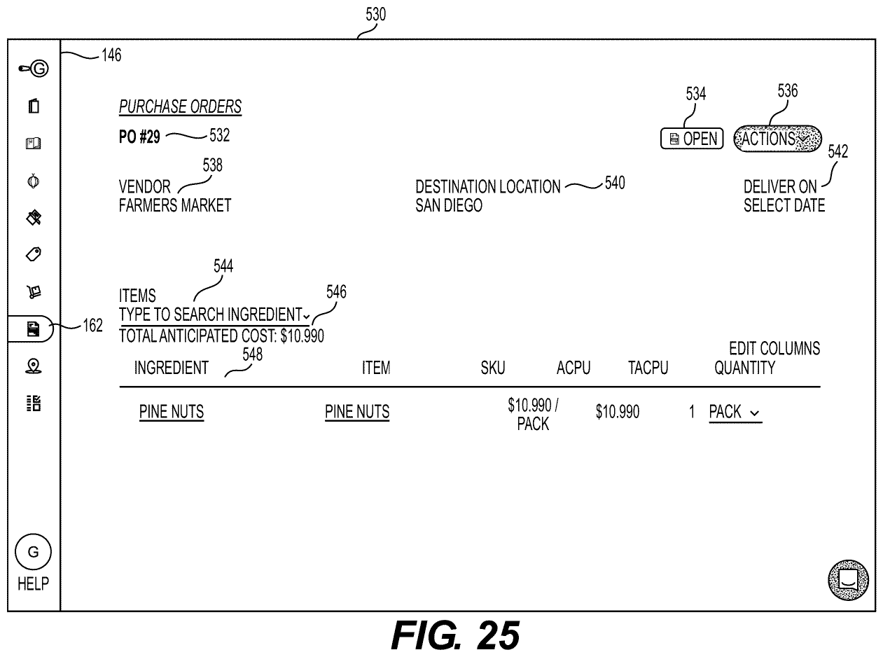

Purchasing can include building and managing purchase orders and tracking deliveries. For this purpose, the system 100 can include a purchasing module 116, purchase order state tracking module 112, and receiving module 110. FIGS. 24 and 25 illustrate pages of the user interface where a user can build and manage purchase orders and track deliveries.

The purchasing module 116 can be configured to build purchase orders based on data input by the user via the user interface and/or automatically build purchase order based on data provided from the menu planning module 120. The purchasing module 116 can receive vendor and vendor item related data from the vendors module 124.

The purchase order state tracking module 112 can be configured to track the state of a purchase order. The purchase order state tracking module 112 can receive data related to purchase order tracking via the user interface and/or provided by the vendor via the vendor integration module 118. The purchase order state tracking module 112 can further be configured to provide user-provided order state information to a vendor via the vendor integration module 118.

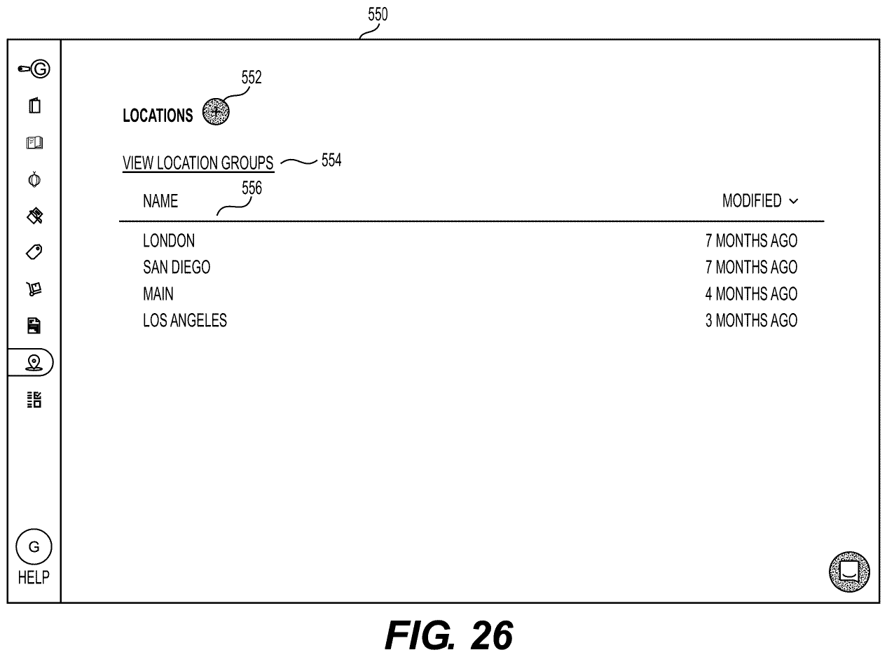

The receiving module 110 can be configured to provide receiving data to the real time inventory module 106 that can be used by the real time inventory module 106 to automatically update the inventory database maintained by the real time inventory module 106. For instance, the real time inventory module 106 can provide a list of vendor items received in the purchase, the location of delivery (associated with a location input in the user interface as illustrated in FIGS. 26 through 29), and the vendor associated with each vendor item.

### User Interface

FIG. 2 illustrates an example dashboard page 144 of the user interface of the system 100. The dashboard page 144 includes a navigation ribbon 146, quick-access category panes 170, 172, 174, and a chat button 176. The navigation ribbon 146 includes a dashboard button 148, a menus button 150, a recipes button 152, an ingredients button 154, a preparations button 156, a categories button 158, a vendors button 160, a purchase orders button 162, a locations button 164, an inventories button 166, a user settings button 168, and a help button 169. In some examples, the navigation ribbon 146 can include more or fewer navigation buttons depending on the specific use and implementation of the system 100. Each of the buttons 148-166 links to page of the user interface as illustrated in FIGS. 3 through 35 which allow the user to navigate to pages where they are able to interact with various modules of the system 100 illustrated in FIG. 1. The quick-access category panes 170 include links to recently used menus, recipes, and ingredients respectively. The user settings button 168 navigates the user to a page which displays user account information such as user name, role, location, and e-mail and allows the user to perform account-relation actions such as logging out or changing their password. The help button 169 and chat button 176 function identically, causing a help window to appear above the chat button 176. The help window includes a button to start a chat conversation with a customer support associate and a search field for searching help articles.

FIGS. 3A and 3B illustrate an example menus browser page 178 of the user interface of the system 100. FIG. 3A illustrates the page 178 when no listed menu is selected. FIG. 3B illustrates the page 178 when one or more listed menus are selected. The menus button 150 is highlighted in the navigation ribbon 146 to indicate that the present page is associated with menu planning. Menu planning pages provide an interface to a menu planning module 120 illustrated in FIG. 1.

The illustrated menus browser page 178 includes an add menu button 180, a select all button 181, a filter button 182, an edit columns button 179, a menu name list 184, a location list 186, a service date list 188, and a date modified list 190. The add menu button 180 provides a link to page(s) which allow the user to build a menu. The edit columns button 179 displays a pop-up window including a list of columns that are optionally available to add to the menu table. Optional columns can include user defined categories as described in further detail in relation to FIGS. 16 and 17.

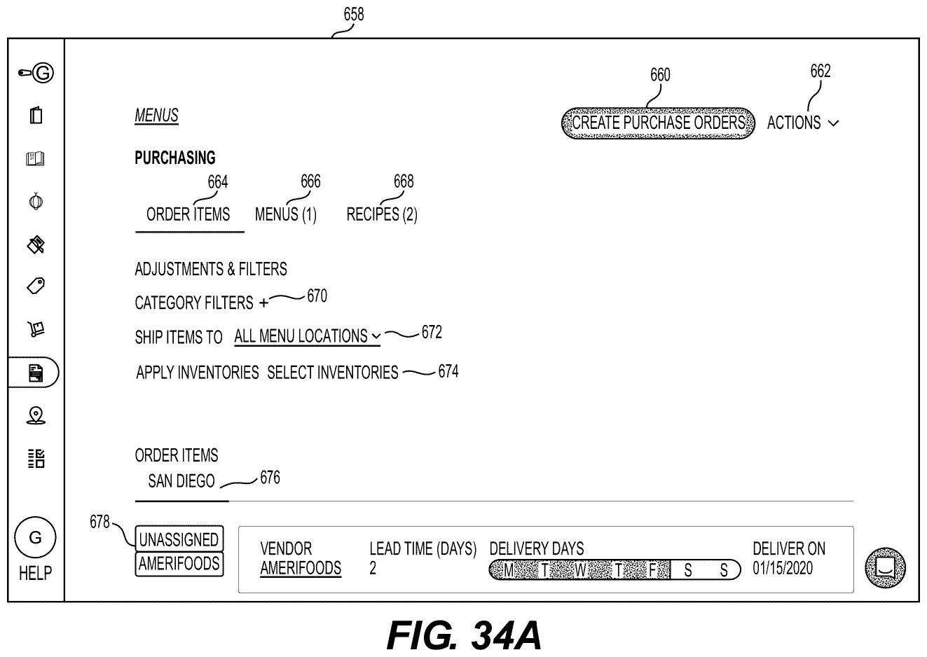

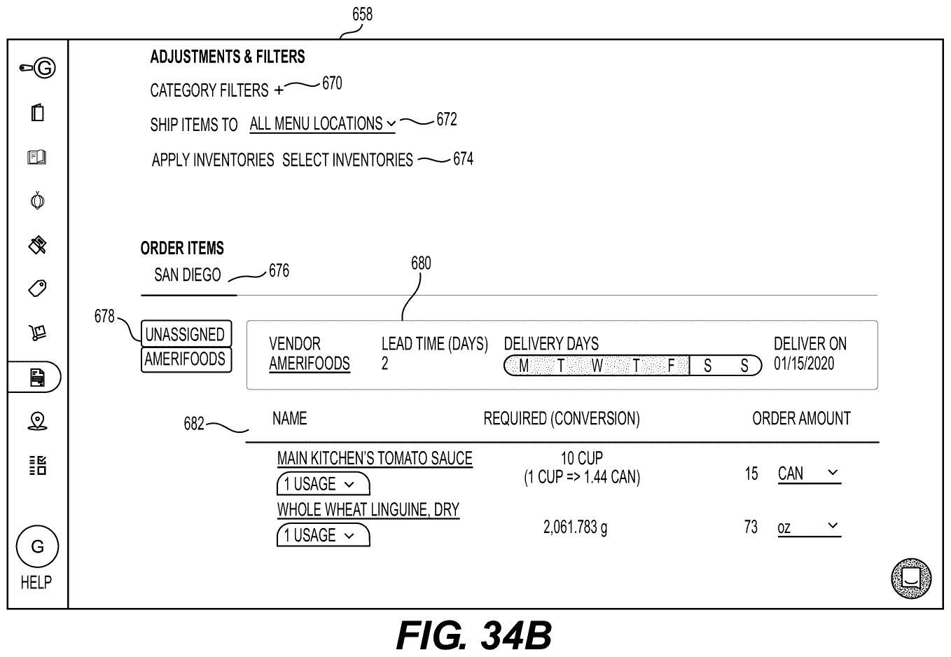

Each row of the name 184, location 186, service date 188, and modified date 190 columns are associated with a menu. Each row is clickable to navigate the user to page(s) associated with the respective menu. When no listed menus are selected as illustrated in FIG. 3A, hovering over a row causes a clickable circle to appear to the left of the menu name. All menus in the list can be selected by clicking the select all button 181. Selecting a menu item causes a menu selection indicator 183, an inventory query button 185, a purchasing button 187, a production planning button 189, and a bulk delete button 191 to appear. The menu selection indicator 183 displays how many menus are selected. Clicking the inventory query button 185 navigates the user to an inventory creation page 648 such as illustrated in FIG. 33 that is prepopulated with ingredients and quantities from each recipe in each selected menu. Clicking the purchasing button 187 navigates the user to a purchasing page 658 such as illustrated in FIGS. 34A and 34B that is prepopulated with vendor items for each recipe in each selected menu. Clicking the production planning button 189 navigates the user to a production list page 684 such as illustrated in FIG. 35 that is prepopulated with a list of each selected menu and a list of recipes associated with the selected menus.

The filters button 182 allows provides a pop-up window which allows the user to display only menus satisfying the filters. Menus can be filtered based on name, location, service date, date modified, other criteria, or any combination thereof.

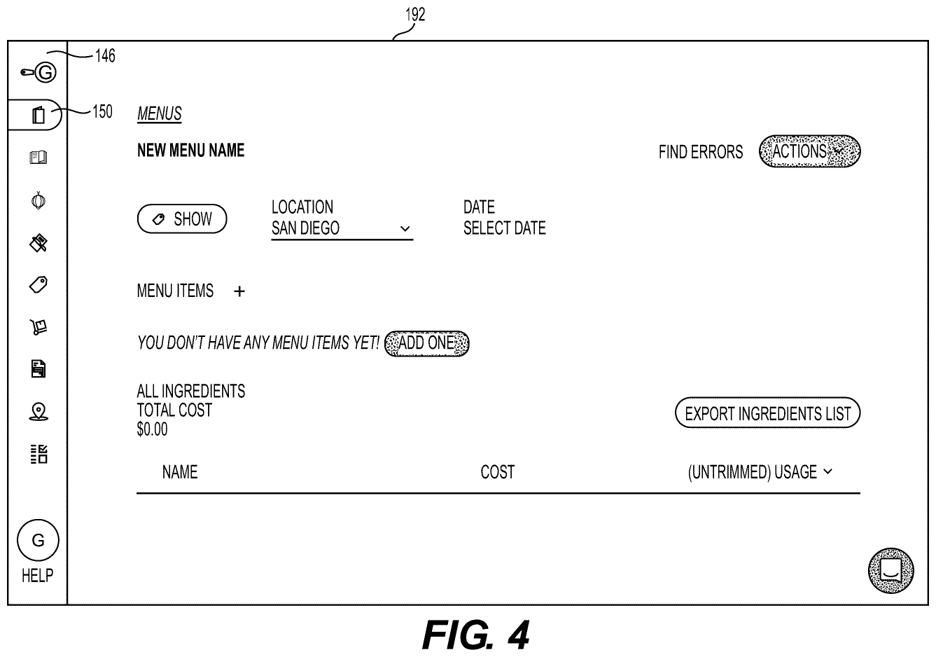

FIG. 4 illustrates an example menu creation page 192 of the user interface of the system 100. The user can navigate to this page by clicking the add menu button 180 on the menus browser page 178 in FIG. 3.

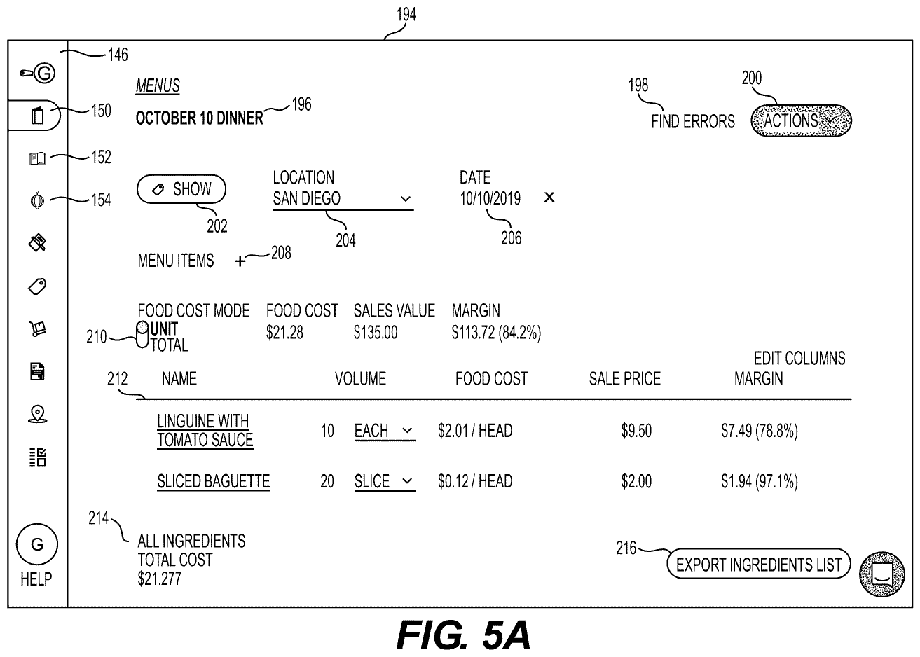

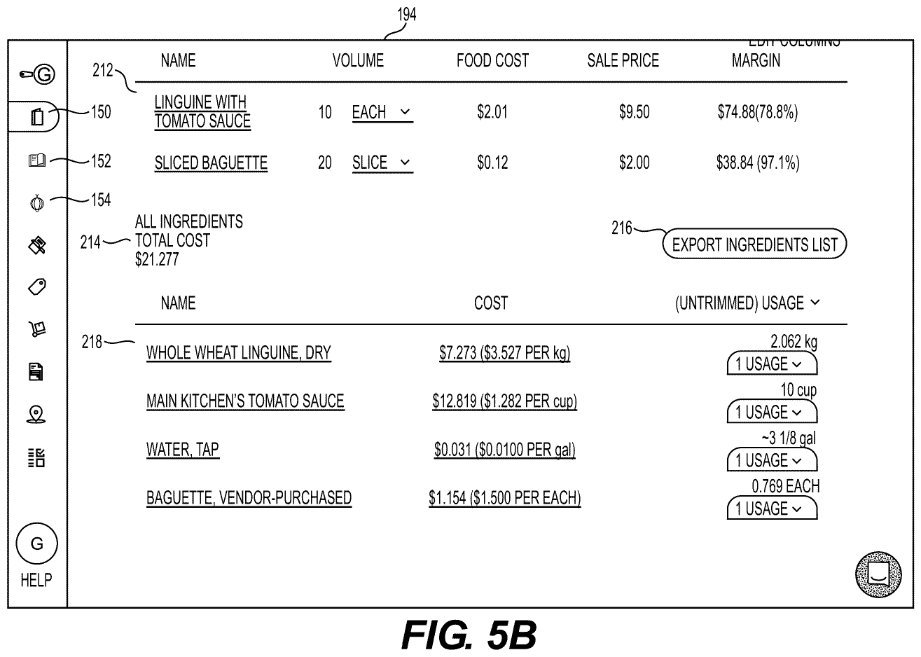

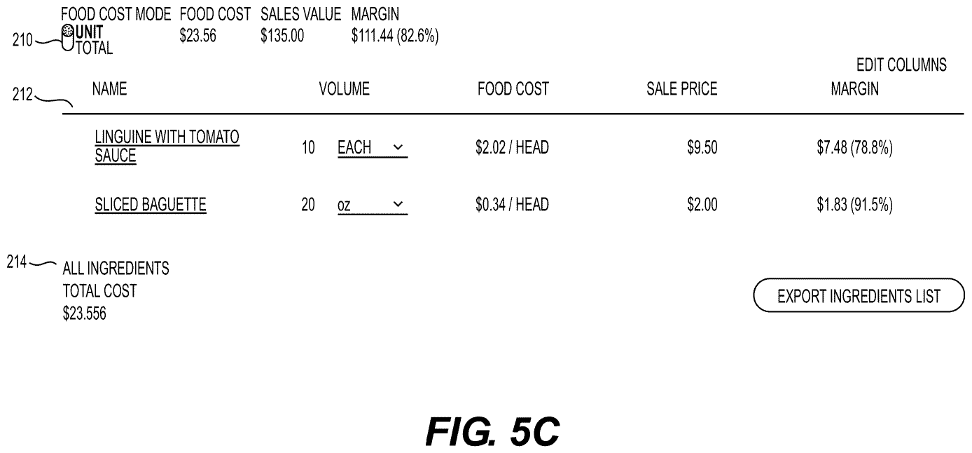

FIGS. 5A and 5B illustrate an example menu page 194 of the user interface of the system 100. A user can view the page by scrolling down from the image illustrated in FIG. 5A to the image illustrated in FIG. 5B. The menu page 194 includes the menu name 196, a find/hide errors button 198, an actions button 200, a tags button 202, a location field 204, a date field 206, an add menu items button 208, a food cost toggle button 210, a recipe table 212, an ingredients cost calculation 214, an export ingredients button 216, and an ingredients table 218. The menu name 196, tags (under the tags button 202), location field 204, and date field are editable and generated at the menu is created, for instance via the menu creation page 192 illustrated in FIG. 4.

The find/hide errors button 198 toggles between a find state and a hide state where errors in the menu are visible in the find state and errors are hidden in the hide state. When the errors button 198 is in display mode, errors the system discovers for the given menu are displayed. Errors can be determined based on whether the system has all information required to properly scale the recipes within a menu (i.e. are all units compatible and convertible) as well as provide costing information (i.e. do all ingredients have costing information).

The actions button 200, when clicked, provides a drop-down menu with selectable actions including copy, file export, and delete. The copy action generates an editable copy of the menu page. The copy is otherwise unassociated with the original menu. The file export action downloads a file including menu data.

The tags button 202 can cause a list of tags to be displayed. Each tag can be a user-defined tag to aid the user in searching. Each tag can include a category and value as discussed in greater detail in relation to the example category page 424 illustrated in FIG. 17. Recipes within the menu can have variations dependent on the location of service. For instance, a recipe generated for a San Diego, California location might include avocados as a salad topper, and the recipe can have a variation for a London location that omits or substitutes the avocados, but otherwise follows the same recipe. The user can toggle between variations of the same menu by selecting a location at the location field 204.

Menu items can be added to the recipe table 212 by clicking the add menu items button 208. Clicking the add menu item button 208 provides a pop-up window for searching recipes. Once a recipe is found, it can be added to the recipe table 212 as a new row. Ingredients associated with the added recipe are automatically populated in the ingredients table 218. Once in the recipe table 212, the volume of the recipe can be selected by entering a quantity and selecting a unit of measurement from a drop-down menu. Each ingredient in the recipe can be associated with a food cost per volume as indicated in the cost column of the ingredients table 218. The food cost column of the recipe table 212, the total cost 214, and the (untrimmed) usage column of the ingredients table 218 are automatically populated when the volume quantity and unit are entered in the recipe table 212. The ingredients table 218 can further display to which recipe(s) the ingredients are associated with via drop-down menus in the (untrimmed) usage column. In the recipe table 212, the user can enter a sale price under the sale price column. The dollar amount and/or percentage of margin displayed in the recipe table 212 can then be automatically calculated and displayed such that the calculation is based on the food cost (based on volume) and sale price. Food cost in the food cost column of the recipe table 212 can be displayed per unit (e.g. per head or person as illustrated) or total. In the illustrated example, toggling the food cost toggle button 210 displays the food cost of “Linguine with Tomato Sauce” as $20.10 total and the food cost of “Sliced Baguette” as $1.16.

FIG. 5C illustrates the recipe table 212 and ingredients cost calculation 214 illustrated in FIG. 5A updated to demonstrate the system's ability to calculate a per head cost per recipe and per menu when at least one of the recipes in the menu is expressed in a unit quantity of volume. In the example, the sliced baguette quantity is entered in ounces rather than slices as illustrated in FIG. 5A. The cost per unit head in the “FOOD COST” column of the recipe table 212, the total cost 214, and sales margin are updated accordingly.

Referring to FIG. 1, the menu planning module 120 is configured to receive data from the recipe catalog module 132. The recipe catalog module can be configured to provide to the menu planning module 120 data related to recipes, ingredients accessed via the ingredients catalog module 134, and costing accessed via the costing module 136. This functionality is demonstrated at the user interface by virtue of the menu page 194 providing access to search the recipe catalog and import data associated with a given recipe to the recipe table 212 and populate the ingredients table 218 based on the chosen recipes. The recipe catalog module 132, ingredient catalog module 134, and costing module 136 are each in communication with the other two modules such that ingredients and costs are associated with each recipe accessed by the recipe catalog module 132. The menu planning module 120 can provide recipe volume and sale price data entered by the user to the costing module 136. The costing module 136 can access an ingredient cost database in which each ingredient is associated with a food cost per volume. Given quantities of ingredients for each recipe indicated in the menu, the ingredient cost per volume, and the volume of each recipe, the costing module 136 can calculate the food cost and provide the food cost to the menu planning module 120. This functionality is demonstrated at the user interface by virtue of the food cost column automatically populating when food volume is entered. Further given the sale price for each recipe, the costing module 136 can calculate the ceiling profit margin. This functionality is demonstrated at the user interface by virtue of the margin column of the recipe table 212 automatically populating when the food cost is calculated, and the sale price is entered.

Referring collectively to FIGS. 1, 5A, and 5B, each of the recipe names in the recipe table 212 includes a link to page(s) to interface with the recipe catalog module 132. Such pages are indicated by a highlighted recipe button 152.

FIGS. 6A and 6B illustrate an example recipe browser page 220 of the user interface of the system 100. The recipes button 152 is highlighted in the navigation ribbon 146 to indicate that the present page is associated with the recipes database. Recipe pages provide an interface to the recipe catalog module 132 illustrated in FIG. 1. The illustrated page 220 includes an add recipe button 222, a recipe search field 224, a filter button 226, an edit columns button 228, and a recipe table 230. The add recipe button 222 provides a link to page(s) which allow the user to build a recipe.

Each row of the recipe table 230 is associated with a recipe accessible by the recipe catalog module 132. Each row is clickable to navigate the user to page(s) associated with the respective recipe. The filters button 226 allows provides a pop-up window which allows the user to display only recipes satisfying the filters. Recipes can be filtered based on concepts, whether the recipe is tagged as sellable, whether recipe is used or unused, a category tag, other criteria, or any combination thereof.

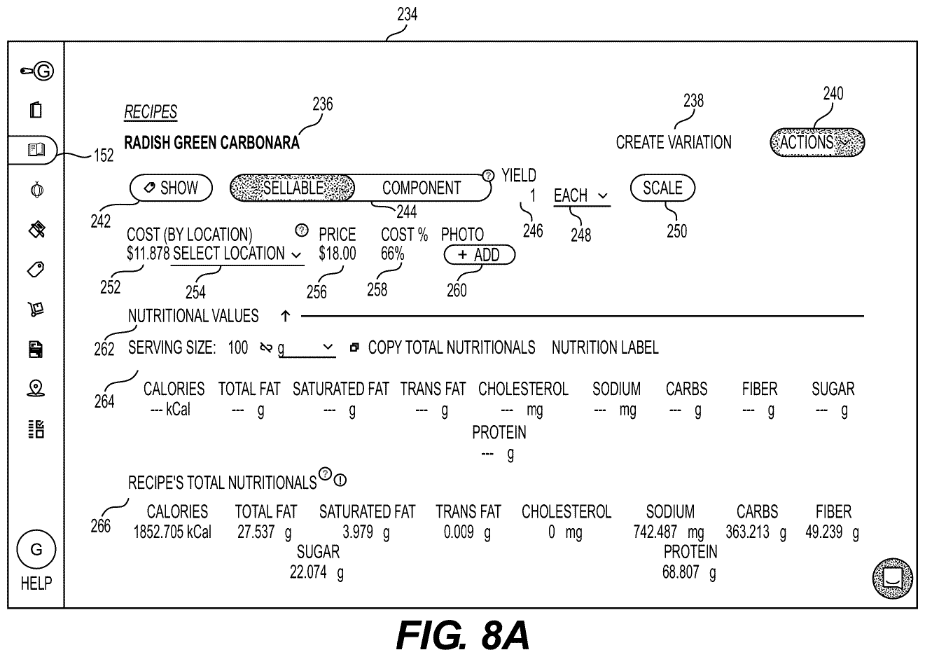

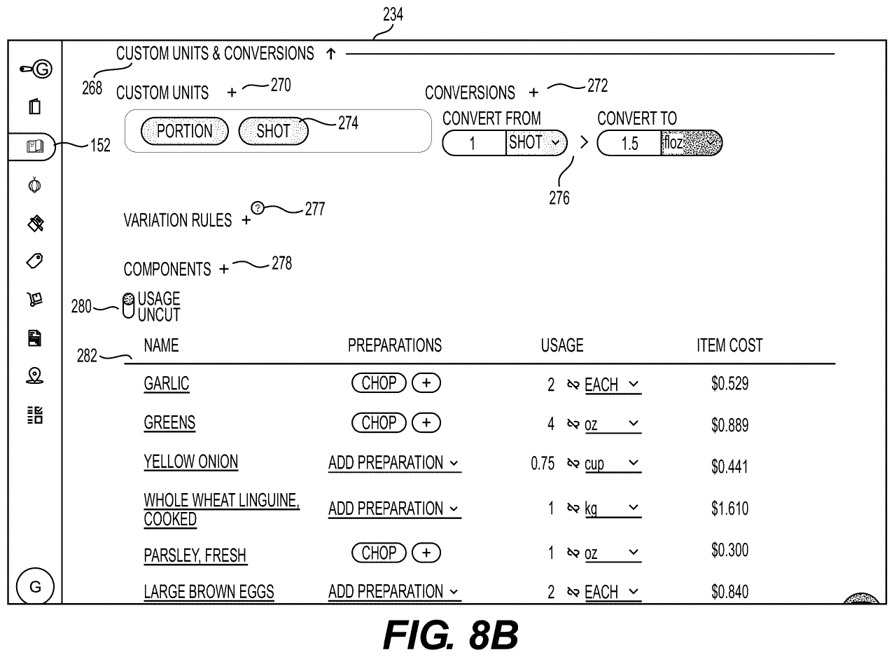

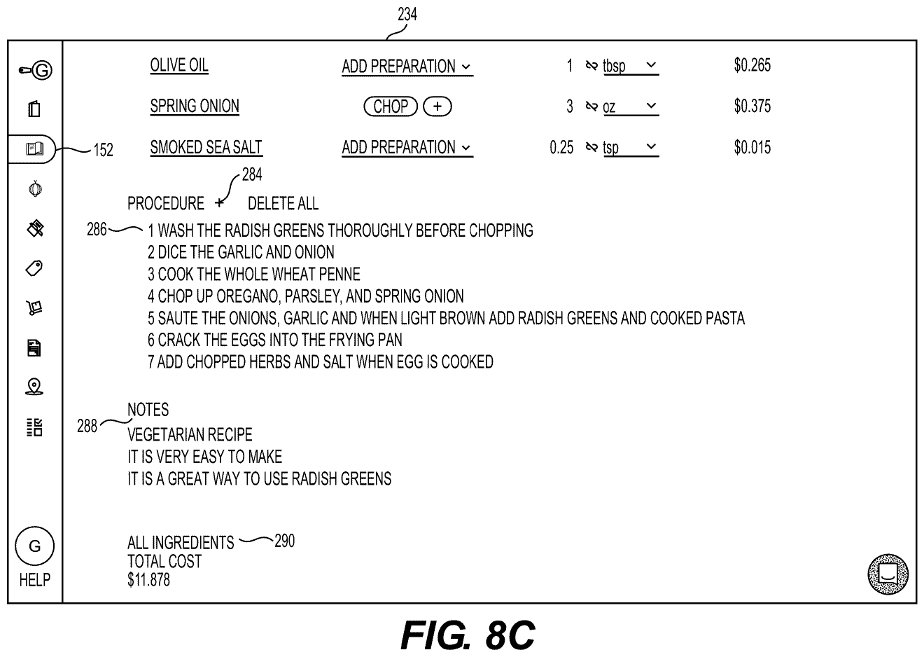

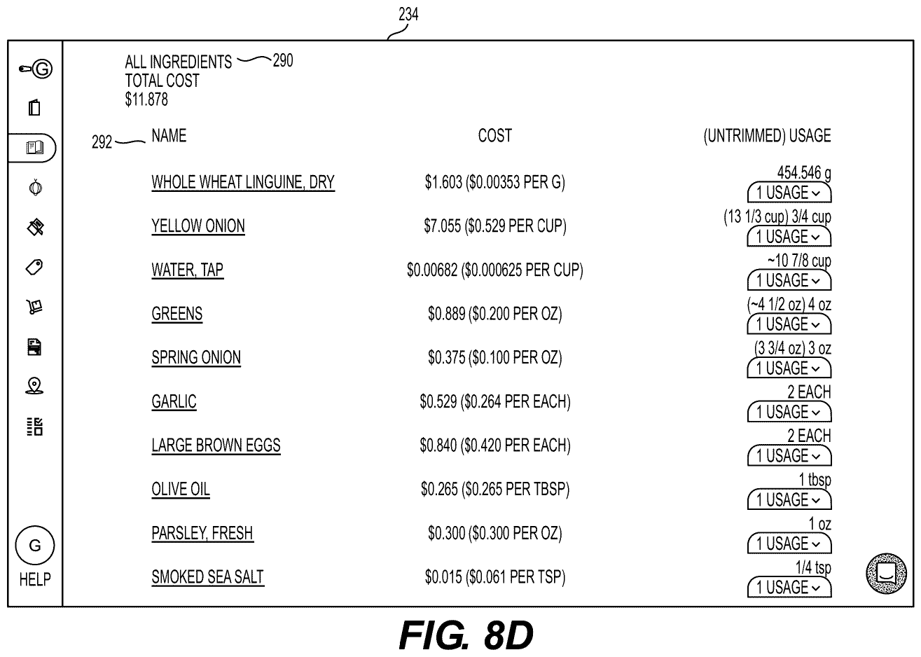

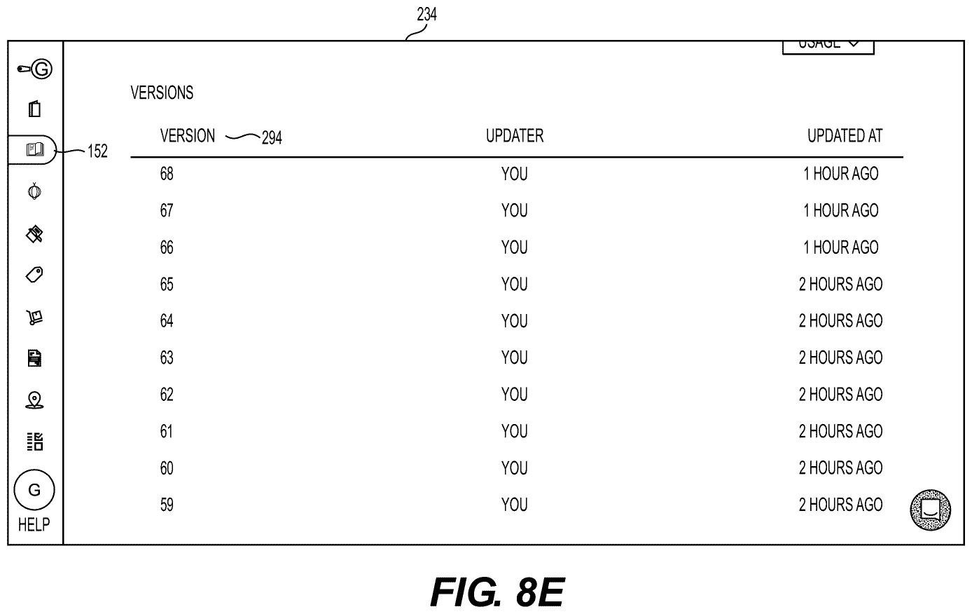

FIG. 6B illustrates the recipe browser page 220 of FIG. 6A when recipes are selected in the recipe table 230. Hovering with the mouse cursor over a row of the recipe table 230 when no recipes are selected as illustrated in FIG. 6A causes a clickable circle to appear to the left of the recipe name. Clicking the circle selects the recipe and causes a lower menu bar 221 to appear as illustrated in FIG. 6B. The lower menu bar 221 includes a selection indicator 223, an export button 225, a bulk tag button 227, a bulk edit button 229, and a bulk delete button 231. The selection indicator 223 indicates the number of recipes selected in the recipe table 230. The export button 225, when clicked, causes a pop-up window to appear which includes options for exporting the selected recipes. The recipes can be exported as separate files (e.g. CSV files). The ingredients for all recipes can be exported in a single file including the quantity of each ingredient and the recipe(s) associated with each ingredient. The bulk tag button 227, when clicked, causes a pop-up window to appear which includes a tag with a selectable tag name and tag value and an add tag button which cases additional tags to appear. The bulk edit button 229, when clicked, causes a pop-up window to appear in which the user can update all selected ingredients as either a “sellable” or a “component” recipe. Setting “sellable” or “component” in this way edits the sellable/component toggle button 244 on each recipe page 234 as discussed in further detail in relation to FIGS. 8A through 8E. The bulk delete button 231, when clicked, deletes the selected recipes.

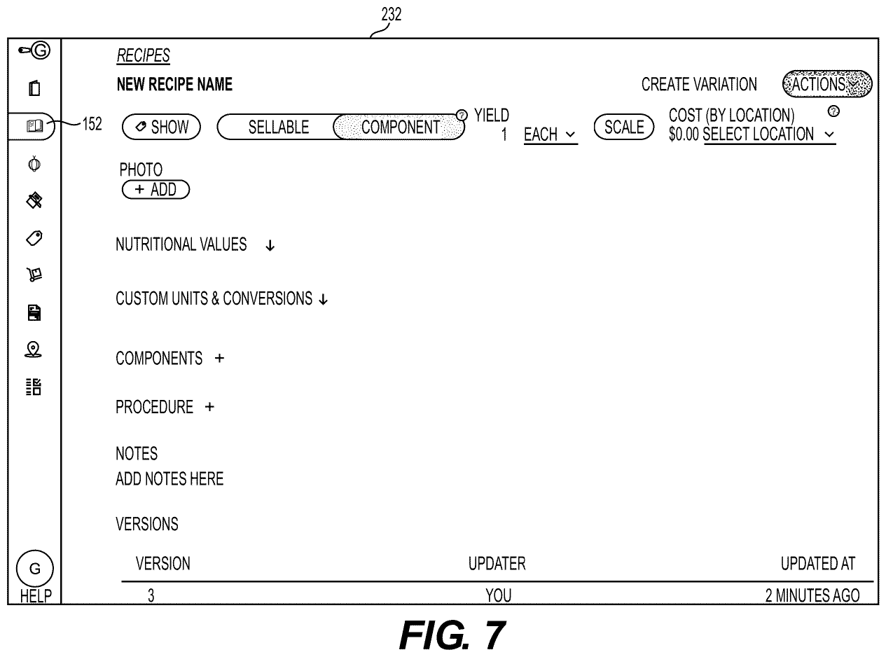

FIG. 7 illustrates an example recipe creation page 232 of the user interface of the system 100. The user can navigate to this page by clicking the add recipe button 222 on the recipe browser page 220 in FIG. 6.

FIGS. 8A through 8E illustrate an example recipe page 234 of the user interface of the system 100. A user can view the page by scrolling down from the image illustrated in FIG. 8A sequentially to the image illustrated in FIG. 8E. The recipe page 234 includes the recipe name 236, a create variation button 238, an actions button 240, a tags button 242, a sellable/component toggle button 244, a yield text field 246, a units dropdown list 248, a scale button 250, a cost by location display 252, a location field 254, a price field 256, a cost percent display 258, an add photo button 260, a nutritional values section 262, a custom units section 268, an add variation rule button 277, an add components button 278, a usage/uncut toggle button 280, an add procedure list button 284, a procedure list 286, a notes section 288, an ingredients cost display, an ingredients cost table 292, and a version tracker table 294.

In general, a user can interact with the recipe page 234 in the way a user interacts with a recipe creation page 232 after the recipe creation page 232 is populated.

A user can edit the name of the recipe name 236 by clicking and editing the text of the recipe name 236.

The user can create a variation of the recipe by clicking the create variation button 238. When the create variation button 238 is clicked, the user is navigated to a page prompting for a recipe variation name. Once the name of the recipe variation is entered, the system 100 generate a new recipe in the recipe database accessible by the recipe catalog module 132. The variation is linked to the original recipe. Components, procedure, and cost associated with the original recipe are copied over the variation recipe by default. The user is navigated to a recipe variation page where the user can delete, add, and edit quantities of components and the procedure. The variation page includes an ingredients cost table, cost by location display, and location field similar to the ingredients cost table 292, cost by location display 252, and location field 254 on the example recipe page 234. The variation page further includes a create variation button similar to the create variation button 238 on the example recipe page 234 with the exception that the button provides a pop-up window which allows the user to choose to create a new variation of the present variation or a variation of the original recipe.

The actions button 240 provides a pop-up window which allows the user to select one of a collection of actions such as copying the recipe, exporting the recipe to PDF or other file format, exporting the ingredients list only, deleting the recipe, other such action, or any combination thereof.

The tags button 242 can cause a list of tags to be displayed. Each tag can be a user-defined tag to aid the user in searching. Each tag can include a category and value as discussed in greater detail in relation to the example category page 424 illustrated in FIG. 17.

The sellable/component toggle button can be clicked by the user to indicate whether the recipe, when executed results in a food item that is sellable on its own (e.g. by selecting “sellable”) or results in a food item that itself is a component of another recipe and not sellable on its own (e.g. by selecting “component”).

The yield text field 246 can be edited to indicate a number of units of food items that are yielded when the recipe is executed. From the units dropdown list 248, a user can select a unit of measurement associated with the number of units in the yield text field 246. The dropdown list can include units of measurements such as portion, cup, each, fluid ounces, grams, gallons, kilograms, liters, pounds, milliliters, ounces, pints, quarts, teaspoons, tablespoons, etc. The dropdown list can further include units that are user defined. Custom units can be defined by the user in the custom units section 268 of the recipe page 234 as discussed in further detail below. Updating the yield field 246 and/or units dropdown list 248 does not affect the information on the example recipe page 234. Editing the yield field 246 and/or units dropdown list 248 can affect the cost of a menu which includes the recipe. For instance, referring to the example menu page 194 illustrated in FIGS. 5A and 5B, if, on the recipe page associated with the “Linguine with Tomato Sauce”, the yield field is changed such that the recipe (otherwise unaltered) yields more units of food items (regardless of the units used), the food cost displayed in the menu item table 212 would automatically go down. This makes sense because the recipe, having an unchanged total cost, yields more units of food items, and therefore costs less per unit. It should be noted that the unit selected in the units dropdown list 248 of the recipe page 234 need not match the units selected in the volume column of the menu item table 212 for that recipe. The system 100 can be configured to convert between units available via the dropdown list 248 and units available for selection in the respective row of the menu item table 212.

The scale button 250 causes the nutritional value per serving size displayed in the nutritional value per unit calculator 264 of the nutritional values section 262 to update.

A given recipe (and each variation thereof) can respectively be associated with a location of service. For instance, a recipe for which a San Diego, California location is selected might include avocados as a salad topper while a variation of the same recipe for which a London location is selected might omit or substitute the avocados, but otherwise follow the same recipe. The user can select which location the displayed recipe is associated with by selecting a location from a dropdown list at the location field 254, the dropdown list appearing when the user clicks the location field 254. The cost by location shown in the cost by location display 252 illustrates the total cost of the recipe. The total cost of the recipe can be dependent on the location selected in the location field 254. The total cost of the recipe in the display 252 can be updated automatically when the user selects a different location from the location field 254. In some examples it can be advantageous to link the recipe to a default location from which the total cost is calculated absent the user selecting a location from the location field 254. FIG. 8A illustrates a total cost shown in the cost by location display 252 while no location is selected in the location field 254.

The price field 256 can be edited by the user to indicate the price charged to a customer for the total quantity of food items made when the recipe is executed. The cost percent display 258 can automatically update based the cost and price. For instance, the cost percent display 258 can show the cost in the cost by location display 252 divided by the price in the price field 256.

The add photo button 260 can be clicked to navigate the user to an interface where the user is able to associate an image file with the recipe.

The nutritional values section 262 includes a nutritional value per unit calculator 264 and a total nutritional value table 266. The nutritional value per unit calculator 264 can include a servings input field and a units dropdown list from which the user can choose to calculate nutritional value of a given unit independent of the yield and units input at the yield field 246 and units dropdown list 248 for the total recipe. The nutritional values section 262 can further include a total nutritional value table 266 that includes the nutritional value of the total quantity of food items generated when the recipe is executed. Nutritional values can be calculated based on information gathered from various databases (including the United States Department of Agriculture FoodData Central database, a database maintained by the website service provider, and/or other accessible databases) and/or nutritional information input by the user. Nutritional values can be calculated based on the quantity of usage of the components (e.g. ingredients and component recipes) of the recipe. Nutritional values can further be calculated based on the method of preparation of some or all of the components.

The custom units section 268 can include an add custom units button 270, an add conversion button 272, a new portion field 274, and a conversion calculator 276. From the custom units section 268, a user is able to add a custom unit of food measurement. For instance, if the user wishes to serve alcohol and it is more convenient for the user, in some instances, to define quantality of alcohol in “shots” having a volume of 1.5 fluid ounces. Without being able to define a custom unit of measurement, the user would be forced to select the most convenient available unit and then perform conversion calculations themselves, which leads to more work on the part of the user and potentially more error. To enter the “shots” custom unit, a user can first click the add custom units button 270 which causes an unnamed new portion field 274 to appear, which the user can select by clicking then enter the appropriate text (e.g. “shot” in the given example). Next, the user can click the add conversion button 272 to cause the conversion calculator 276 to appear. The conversion calculator 276 allows the user to equate a quantity of the user defined units to a quantity of a unit already known to the system 100.

The add variation rule button 277 appears when the recipe has a variation, for instance as a result of adding a variation by clicking the create variation button 238. When the user clicks the add variation rule button 277, the user has the option to set rules that will determine when the variation will automatically be used when the given recipe is added to a menu. The user can add rules for each variation that exists for a given recipe. For instance, the rule can be location based. The rule can associate the variation with one or more locations such that menus associated with one of the locations (which also include the recipe) will automatically populate with the given recipe variation.

The add components button 278 allows the user to add a component to the components table 282, which includes components (ingredients or sub-recipes) of the recipe.

The usage/uncut toggle button 280 toggles the usage quantities displayed in the usage column of the components table 282 between the quantity used and the uncut quantity. The uncut quantity (as referred to as “untrimmed” herein) indicates the approximate percentage of the ingredient which remains after removing trim waste. For instance, a portion of a whole yellow onion such as the outer layer of skin and the base of the onion are trimmed during preparation such that a total quantity of 0.83 cups of untrimmed onion yields about 0.75 cups after trimming. Whole yellow onions are purchased uncut, therefore the relationship between the actual usage in the recipe and the uncut quantity affects the calculated cost of the ingredient. When “usage” is selected by the toggle button 280, the usage column of the components table 282 displays 0.75 cups of yellow onion. When “uncut” is selected by the toggle button 280, the usage column of the components table 282 displays 0.83 cups of yellow onion and the heading of that column displays “UNCUT” rather than “USAGE”. Similarly, the usage is updated for other components when the toggle button 280 is clicked. The components table 282 and the recipe page 234 is otherwise unaffected by toggling of the usage/uncut toggle button 280.

The components table 282 includes rows representing preparation, quantity, and cost of each components in the recipe. The user can navigate to the page of a given component (e.g. ingredient page for ingredient or recipe page for recipe) by clicking the name of the component in the “NAME” column. In the illustrated example recipe page 234, the “Whole Wheat Linguine, Cooked” component is a recipe that is not sellable (i.e. the sellable/component toggle button 244 of the recipe page is toggled to “COMPONENT”). The remainder of the components in the illustrated components table 282 are ingredients. The user can add preparations by clicking an add button and/or selecting from a dropdown list in the “PREPARATIONS” column. The user can type and/or select a quantity and unit in the “USAGE” column when usage is selected by the usage/uncut toggle button 280. When uncut is selected by the usage/uncut toggle button 280, the “UNCUT” column is locked from editing. Values in the item cost column are calculated based on the usage column and are not editable from the components table 282.

The add procedure button 284, when clicked, adds a step to the procedure list 286. The user can update the text of the step by clicking on the added step in the procedure list 286. Further, the user can edit the text of an existing step by clicking on the text of that step. The user can reorder steps by clicking and dragging a given step up or down over the procedure list 286 then releasing the step at the desired location in the list 286. When a user hovers over the text of the step in the procedure list, an “x” appears next to the step. The user can delete the step by clicking the “x”.

The notes section 288 includes text that can be edited when the user selects the text or positions the cursor and types.

The ingredients cost display 290 is a repeat of the cost by location display 252 at the top of the page. The ingredients cost display 290 is repeated on the page 234 above the ingredients cost table 292 for ease of readability.

The ingredients cost table 292 includes the name, cost, and usage for each ingredient. The ingredients cost table 292 is automatically populated when the user edits the components table 282. Names of each ingredient under the “NAME” column are links to the ingredient page for the respective ingredient. The “(UNTRIMMED) USAGE” column is populated based on values under the “USAGE” column of the components table 282. In the illustrated example recipe page 234, ingredients “whole wheat linguine, dry” and “water, tap” are listed in the ingredients cost table 292 and derived from the recipe “Whole Wheat Linguine, Cooked” listed in the components table 282. The usage and cost of the respective ingredients of the linguine recipe are determined by the usage of the recipe set in the components table 282. In the present example, under the quantity of usage in the ingredients table, each ingredient is indicated as having one usage. For recipes including multiple sub-recipes in the components table 282, ingredients present in multiple recipes appear as a single line item in the ingredients table 292 with the total number of sub recipes in which the ingredient is used for that recipe indicated under the “(UNTRIMMED) USAGE” column.

The version tracker table 294 includes a list of versions created of the given recipe. The version number is clickable to generate a pop-up window that displays components and preparation of the clicked version and the parent recipe side by side for easy comparison. The pop-up window further includes a button which allows the user to create a new recipe from the selected version.

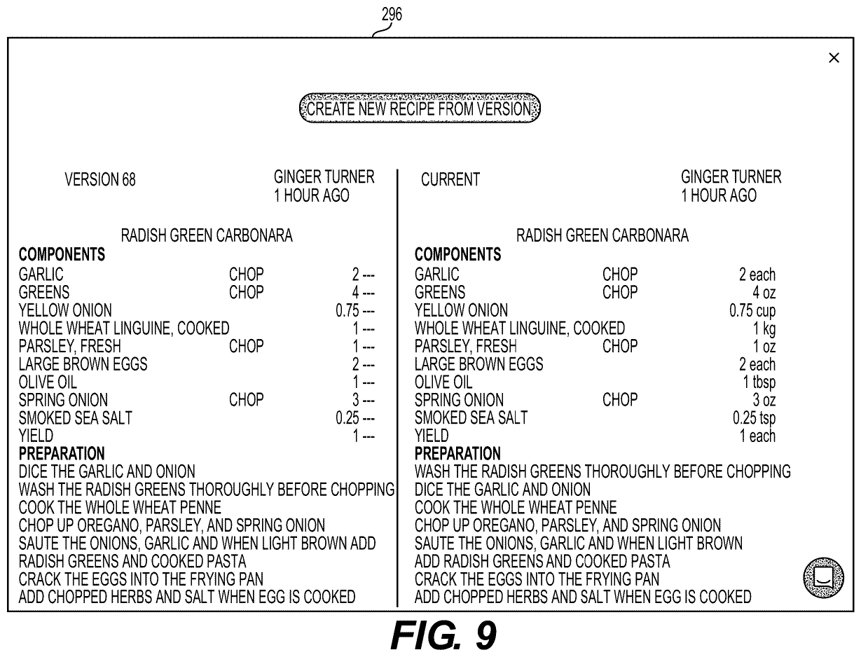

FIG. 9 illustrates an example pop-up window 296 generated when the version number is clicked in the version tracker table 294 on the recipe page 234.

FIG. 10 illustrates an example ingredients browser page 298 of the user interface of the system 100. The ingredients button 154 is highlighted in the navigation ribbon 146 to indicate that the present page is associated with ingredients. Ingredients pages provide an interface to a menu the ingredient catalog module 134 illustrated in FIG. 1. The illustrated page 298 includes an add ingredients button 300, a bulk edit button 302, an ingredients search field 304, a filter button 306, an edit columns button 308, and an ingredients table 310.

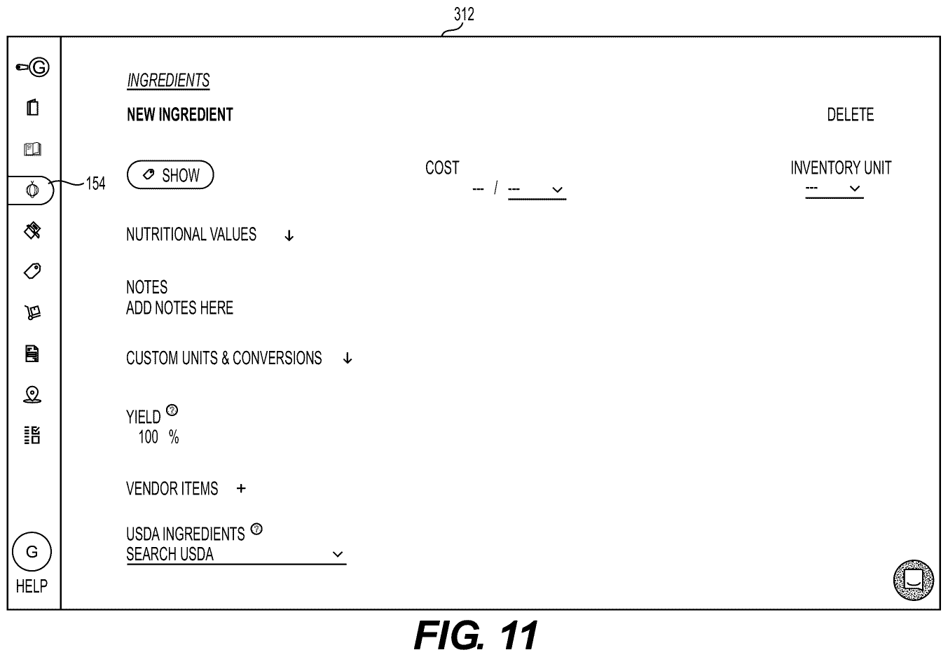

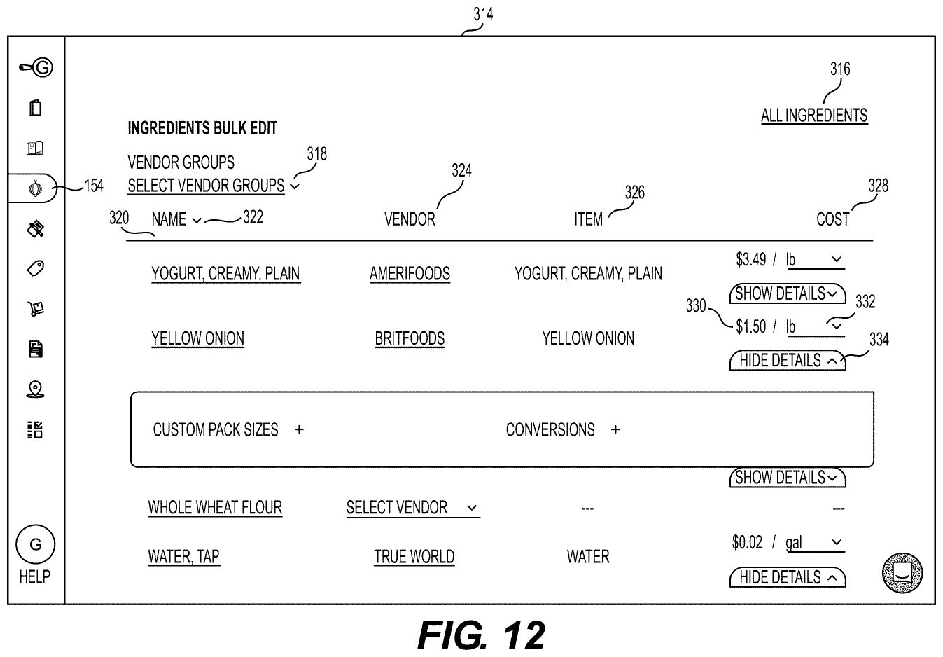

The add ingredient button 300 provides a link to a new ingredient page 312 (FIG. 11) within which the user can add an ingredient to a database accessible by the ingredient catalog module 134. The bulk edit button 302 navigates the user to a bulk edit page 314 (FIG. 12) where the user can edit ingredients in bulk. The ingredients search field 304 causes the ingredients table 310 to display ingredients matching text entered in the search field 304. The filter button 306 provides a pop-up window in which the user can select filter options such as category tag, unused ingredients, ingredients with missing cost, other filter criteria, or any combination thereof. The edit columns button 308 displays a pop-up window including a list of columns that are optionally available to add to the ingredients table 310. For instance, an “INVENTORY GROUP” column can be added to the ingredients table 310 by clicking the edit columns button and selecting “INVENTORY GROUP” from the pop-up window that appears. To remove optional columns from the table 310, a user can hover the mouse over the column heading until an “x” appears next to the column heading, then click the “x”. Another option for removing an optional column is to click the edit columns button 308 and deselecting the optional column. Some columns, such as the “NAME” column, can be fixed, unremovable. Ingredients in the table can be sorted in descending or ascending order by clicking on the heading name of the respective column. Clicking on any row in the ingredients table 310 navigates the user to the respective ingredient page.

The ingredients table 310 lists ingredients in the ingredients database. Hovering over a row in the ingredients table 310 causes a selection circle to appear to the left of the ingredient name. Clicking the selection circle selects the ingredient and cases a menu bar to appear at the bottom of the ingredient browser page 298 similar to the lower menu bar 221 illustrated in FIG. 6B. The lower menu bar on the ingredients browser page 298 lacks a bulk edit button. The export button of the ingredients browser page 298, when clicked, causes a pop-up window to appear which provides the user an option of selecting a location prior to exporting. The exported file includes a table of each ingredient, it's cost, vendor name for that location, vendor item number, vendor item name, cost, category values, and other information present on the ingredients page for each selected ingredient.

FIG. 11 is an illustration of an example new ingredient page 312 which a user can be navigated to by clicking the add ingredient button 300 on the ingredients browser page 298 illustrated in FIG. 10. The new ingredients page 312 includes unpopulated editable fields of an ingredients page discussed in greater detail in relation to FIGS. 13A through 13D.

FIG. 12 is an illustration of an example bulk ingredients page 314 which a user can be navigated to by clicking the bulk edit button 302 on the ingredients browser page 298 illustrated in FIG. 10. The bulk ingredients page 314 provides an interface for a user to edit information associated with ingredients such as cost and custom units without needing to navigate to each individual ingredients page.

The bulk ingredients page 314 includes an all ingredients button 316, a vendor group dropdown list 318, and a bulk ingredients table 320. The all ingredients button 316 navigates the user to the ingredients browser page 298 illustrated in FIG. 10. The vendor group dropdown list 318 allows the user to filter the ingredients in the ingredients table 320 based on the selected group or groups. Vendor groups can be associated with a geographical location (e.g. San Diego or London). Multiple vendor groups can be selected from the vendor group dropdown list 318.

The bulk ingredient table 320 includes a “NAME” column 322, a “VENDOR” column 324, an “ITEM” column 326, and a “COST” column 328. The “NAME” column 322 includes clickable links to respective ingredient pages. The “VENDOR” column 324 includes clickable drop down lists of selectable vendor names and clickable links to pages for selected vendors. The “ITEM” column displays the name of the item as designed by the selected vendor. A row of the “ITEM” column is automatically populated when a vendor is selected from the vendor dropdown list in the “VENDOR” column 324 on that row. A row in the “COST” column 328 can be edited after a valid vendor is selected in the “VENDOR” column 324 of that row; a unit cost field 330, unit field 332, and show details button 334 can appear in the row. The cost field 330 and the unit field 332 can be edited to set the cost of the associated bulk ingredient in the ingredients database accessed by ingredient catalog module 134 (see FIG. 1). The show details button 334, when clicked, can cause a pop-up window to appear in which a user is able to set custom features for the ingredient such as custom order sizes and custom quantity unit conversions. For instance, an ingredient such as canned tomatoes can be sold by a given vendor in various unit quantities such as by the case, pack, or can. In which case, “case”, “pack”, and “can” can be listed under “CUSTOM PACK SIZES” and a conversions from case to pack, pack to can, and one of case, pack, and can to a unit known to the system 100 (e.g. as kilograms or ounces) can be listed under “CONVERSIONS”.

FIGS. 13A through 13D illustrate an example ingredient page 340 of the user interface of the system 100. A user can view the page 340 by scrolling down from the image illustrated in FIG. 13A to the image illustrated in FIG. 13D. The ingredient page 340 includes an ingredient name field 342, a delete button 344, a show tags button 346, a cost per unit calculation display 348, an inventory unit drop down list 350, a nutritional values section 352, a notes section 362, a custom units section 364, a yield percentage display 374, an add vendor item button 376, a vendor table 378, a USDA ingredients density search button 384, and a usages table 392.

In general, a user can interact with the ingredients page 340 in the way a user interacts with a new ingredient page 312 after the new ingredient page 312 is populated.

A user can edit the name of the ingredient by clicking and editing the text of the ingredient name field 342.

The delete button 344 can be clicked to remove the ingredient from being accessed by the user interface for a given user. The ingredient may or may not remain in the ingredients database accessible by the ingredients catalog module 134, for instance if the ingredient is used by another user on a separate user account. Regardless, from the perspective of the user, clicking the delete button 344 effectively deletes the ingredient.

The tags button 346 can cause a list of tags to be displayed. Each tag can be a user-defined tag to aid the user in searching. Each tag can include a category and value as discussed in greater detail in relation to the example category page 424 illustrated in FIG. 17.

The cost per unit calculation display 348 displays the cost per unit of the ingredient. Hovering over the question mark of the cost per unit calculation display 348 causes a pop-up window to appear that includes the basis for the calculation including the food vendor.

The nutritional values section 352 includes a serving size selector 354, a USDA nutritional button 356, a custom calculated nutritional values table 358, and a USDA calculated nutritional values table. The serving size selector allows a user to edit a numeric quantity and unit of measurement of a serving size. The unit of measurement can be a standard unit of measurement or a custom unit of measurement. The USDA nutritional button 356 can be clicked to automatically populate the custom calculated nutritional values table 358 with nutritional values provided by the USDA, i.e. updated to match the USDA Nutritionals table 360. Each numeric field is editable within the custom calculated nutritional values table. This can be useful, for instance, if the vendor provides nutritional information that deviates from the USDA provided nutritional values. The USDA Nutritionals table 360 is calculated based on the USDA provided values and the serving size selected in the serving size selector 354.

Text can be added or edited within the notes section 362 by clicking and typing.

The custom units conversion section 364 includes an add custom units button 366, an add conversion button 368, a custom unit name field 370, and a custom conversion input 372. In the example illustrated, the tomatoes are sold in cases which each weigh a pound. The name of the custom unit can be edited by clicking and typing in the custom unit name field 370. The conversion calculation can be edited at the custom conversion in put 372 by clicking and editing the numeric values and by clicking and selecting a unit of measurement.

The yield percentage display 374 indicates the approximate percentage of the ingredient which remains after removing trim waste. In the present illustration, the yield is estimated at 100%, meaning about 100% of the tomato is usage as a food product. An avocado is an example of a food item where less than 100% (about 50%) of the ingredient remains after the ingredient is trimmed of waste (e.g. skin and seed).

The add vendor items button 376 causes a pop-up window to be displayed which includes a vendor item search field 394, a vendor item search table 396, and a create vendor item input 398. Typing an item name (e.g. “tomato”) in the vendor item search field 394 causes a vendor item search table 396 listing items having a similar item name to appear in the pop-up window. The vendor item search table 396 displays a vendor associated with each item in the same row. A user can add the item to the vendor table 378 by clicking the row of the time in the pop-up window. A user can create a new item at the create vendor item input row 398 by selecting a vendor from a drop-down list and clicking the create button. By clicking the create button, the created item is added to the vendor table 378.

The vendor table 378 includes a reorder handle 380, “VENDOR NAME” column, “VENDOR GROUP” column, “ITEM” column, “COST” column, “SKU” column, “INVENTORY UNIT” column, and item specific custom units tab 382. For a vendor table 378 including multiple rows, the order of the rows can be manipulated by clicking and dragging the reorder handle 380 of the respective row. Names under the “VENDOR NAME” column are clickable to navigate the user to a vendor page in the user interface of the system 100. The “VENDOR GROUP” column is automatically populated based on the vendor name. Names under the “ITEM NAME” column are clickable to navigate the user to an item page associated with the vendor in the “VENDOR NAME” column. The dollar amount and unit in the “COST” column can be edited from the ingredient page 340 illustrated in FIGS. 13A through 13D or from the item page. If the cost is updated on one of the ingredient page or item page, it is automatically updated at the other of the two pages. Further, the calculated cost of menus and recipes which include the ingredient are updated when the cost is updated on the ingredient or item page. Likewise, the “SKU” and “INVENTORY UNIT” columns are editable from the ingredient page and the item page, with one of the two pages updating automatically when the other is edited.

The item specific custom unit tab 382, when clicked, causes a pop-up window to appear that includes a custom pack size 388 per item input and custom conversions 390 per item input. The pop-up window functions to add item specific custom units in a similar manner as the custom units and conversions section 364. When the same ingredient appears on the bulk ingredient page 314 illustrated in FIG. 12 and is associated with a vendor, the custom units conversion section 364 appears when the show details button 334 is clicked. The user can edit the custom units conversion section 364 in the described manner from the bulk ingredient page 314.

The USDA density search button 384 provides a conversion between volume and weight (mass) of the ingredient based on USDA databases. When not populated with a conversion 386, the USDA ingredients density search button includes a text field in which an ingredient name (e.g. “tomato”) can be typed. A drop-down list appears including search results matching the typed name (e.g. “tomatoes, sun dried”, “tomatoes, orange, raw”, etc.) When an item from the list is selected, the USDA ingredient density conversion display 386 is populated. As an alternative, a user can input a custom conversion between a unit of volume and a unit of weight either per item in the units tab 382 or under the custom units and conversions section 364. Volume to weight conversion is ingredient specific as some ingredients (e.g. whipped cream) are light weight for a given volume and other ingredients (e.g. syrup) are heavier for the same given volume. When the USDA density conversion 386 is populated, the system 100 relies on the conversion to calculate units and costs for recipes and menus. An “x” to the right of the USDA density conversion 386 is clickable to remove the USDA density conversion 386.

The usages table 392 lists the recipes in which the ingredient is used along with the quantity of the ingredient in the recipe and the calculated cost. The usages table 392 is populated based on the recipes database and is not editable from the ingredient page 340. Each row of the usages table 392 is clickable to navigate the user to the associated recipe page.

FIG. 14 illustrates an example preparations browser page 400. The preparations browser page 400 includes an add preparations button 402, a search field 404, and a preparations table 406. The add preparations button 402 navigates the user to a new preparations page in which the user can edit the preparation name or delete the preparation. Text can be typed in the search field 404 to display preparations in the table 406 which match the typed text. Each row in the preparation table is clickable to navigate the user to the respective preparation page.

FIG. 15 illustrates an example preparation page 408. The preparation page 408 includes an editable preparation name field 410, a delete button 412, and a usages table 414. If the usages table 414 is populated, clicking the delete button 412 will cause a message to appear stating that the preparation cannot be deleted until the usages are removed from the respective recipes listed in the usages table 414. Each row of the usages table 414 is clickable to navigate the user to the respective recipe page.

FIG. 16 illustrates an example categories browser page 416. The categories browser page 416 includes an add category button 418, a search field 420, and a categories table 422. The add category button 418 navigates the user to a page where the user can enter a category name, select a type from a drop-down menu including menu, menu item, recipe, ingredient, vendor item, and purchase order. Once a type is selected, the user can enter category value names.

FIG. 17 illustrates an example category page 424. The category page includes an editable category name field 426, an item type selector 428, an add category value button 430, category value fields 432, and a delete button 434. The item type selector 428, when clicked, displays a drop-down menu including menu, menu item, recipe, ingredient, vendor item, and purchase order. The drop-down menu is clickable to select an item type. The add category value button 430, when clicked, adds a category value field 432 to the category page 424. Each category value field 432 is editable by clicking and editing the text in the field. Each category value field 432 can be deleted by hovering the mouse over the field 432 and clicking an “x” that appears in the field 432. The delete button 434 removes the category page 424 and redirects the user to the category browser page 416 where the category is no longer listed in the categories table 422.

In the illustrated example, “ingredient” is the selected item type for “inventory group” categories including “produce”, “proteins”, and “dry goods”. The existence of this example category page 424 results in the ability of the user to add an optional “inventory group” column to the ingredients browser page 298 illustrated in FIG. 10 and search the ingredients table 310 based on the classification of ingredients as “produce”, “proteins”, or “dry goods”. An ingredient can be associated with one of the “inventory group” category values via the tags button 346 on the ingredient page 340 as illustrated in FIG. 13A. When a user clicks the tags button 346 on the ingredient page 340, tags already associated with the ingredient are displayed and an add tag button is displayed. Each tag includes a category name (e.g. inventory group) and a category value associated with the category name (e.g. dry goods). Clicking the category name on a tag causes a drop-down menu to appear from which a category name can be selected by clicking. The drop-down menu is populated with category names associated with categories having an item type of “ingredient”. Likewise, on a menu, recipe, vendor item, or purchase order page, the drop-down menu which appears upon clicking a category name of a tag includes only category names associated with the respective item type. Once the category name is selected, clicking the category value on the tag causes a drop-down menu to appear from which a category value can be selected by clicking. Clicking the add tag button creates an unpopulated tag including a blank category name and a blank category value which are each respectively clickable to create respective drop-down menus as per an existing tag.

Whether or not a menu browser page 178, recipe browser page 220, or ingredients browser page 298 includes an edit columns button 228, 308 as described in relation to FIG. 6 and FIG. 10 depends on whether or not any category exists associated with the respective item type (i.e. menu, recipe, or ingredient). Names of optional columns appearing in when the edit columns button 228, 308 is clicked include category names associated with the item type of the respective browser page 220, 298. Categories and values can be managed by the respective module of that item type. For instance, menu categories can be managed by the menu planning module 120, recipe categories can be managed by the recipe catalog module 132, ingredient categories can be managed by the ingredient catalog module 134, etc.

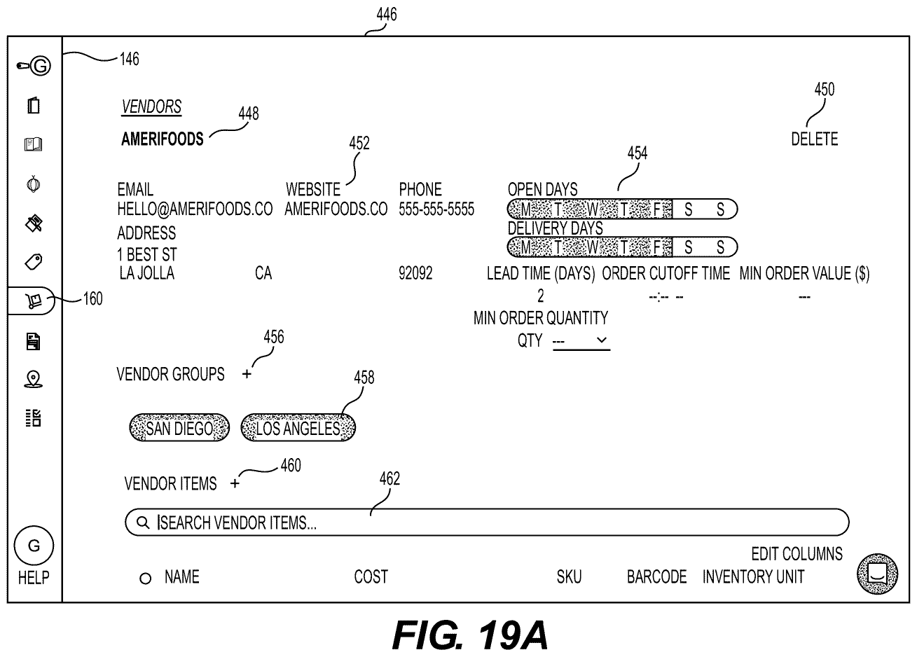

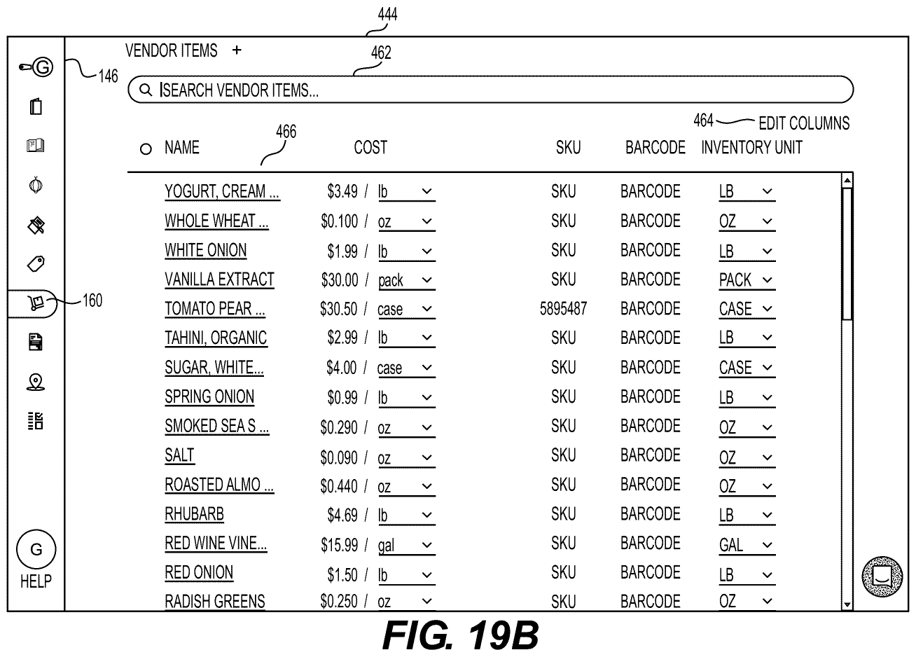

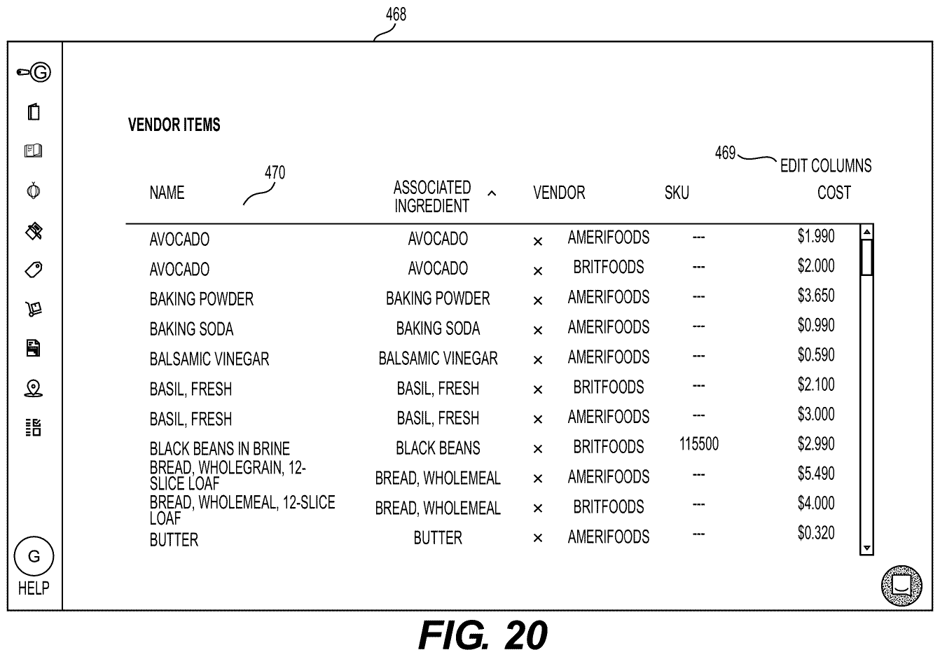

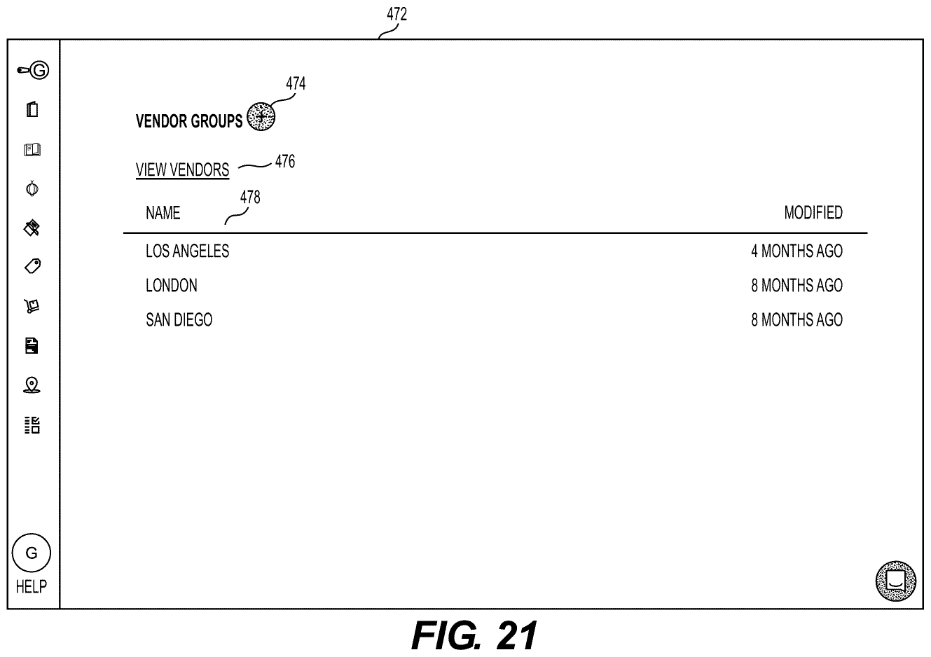

FIG. 18 illustrates an example vendor browser page 436. The vendor browser page includes an add vendor button 438, an all vendor items button 440, a view vendor groups button 442, and a vendor table 444. The add vendor button 438 navigates the user to a vendor creation page including unpopulated editable sections and fields as illustrated by an example vendor page 446 depicted in FIGS. 19A and 19B. The all vendor items button 440 navigates the user to a vendor items browser page as illustrated by an example all vendor item browser page 468 depicted in FIG. 20. The view vendor groups button 442 navigates the user to a vendor group editing page as illustrated by an example vendor group editing page 472 in FIG. 21. Each row of the vendor table 444 is clickable to navigate the user to the respective vendor page. The vendor browser page 436 lacks an edit columns button. In the present example, there are no category item types available through the category page 424 to assign a category to a vendor. An alternative example user interface can include a vendor category item.

FIGS. 19A and 19B illustrate an example vendor page 446 of the user interface of the system 100. A user can view the page by scrolling down from the image illustrated in FIG. 19A to the image illustrated in FIG. 19B. The vendor page 446 includes an editable name field 448, a delete button 450, a vendor contact input section 452, a vendor operation input section 454, an add vendor group button 456, vendor group association(s) 458, an add vendor button 460, a search field 462, an edit columns button 464, and a vendor-specific items table 466. The delete button 450, removes the vendor from being accessible via the user interface. Vendor information may or may remain stored in a vendor database accessible from the vendors module 124 of the system 100 once “deleted” by the delete button 450. The vendor contact input section 452 includes editable fields in which the user can supply an e-mail address, website address, phone number, street address, etc. The vendor operation input section 454 includes editable fields, button, and drop-down lists from which the user can select days of operation, days of delivery, delivery lead time, order cutoff time, dollar amount of a minimum order, quantity of a minimum order, etc.

Clicking the add vendor groups button 456 causes a clickable drop-down menu to appear which lists menu groups not already included as a vendor group association 458. To remove a vendor group association 458, the user can hover with the mouse over the vendor group association 458 and click the “x” which appears on the vendor group association 458. Once removed, the vendor group association 458 appears in the drop-down menu which appears when the vendor groups button 456 is clicked.

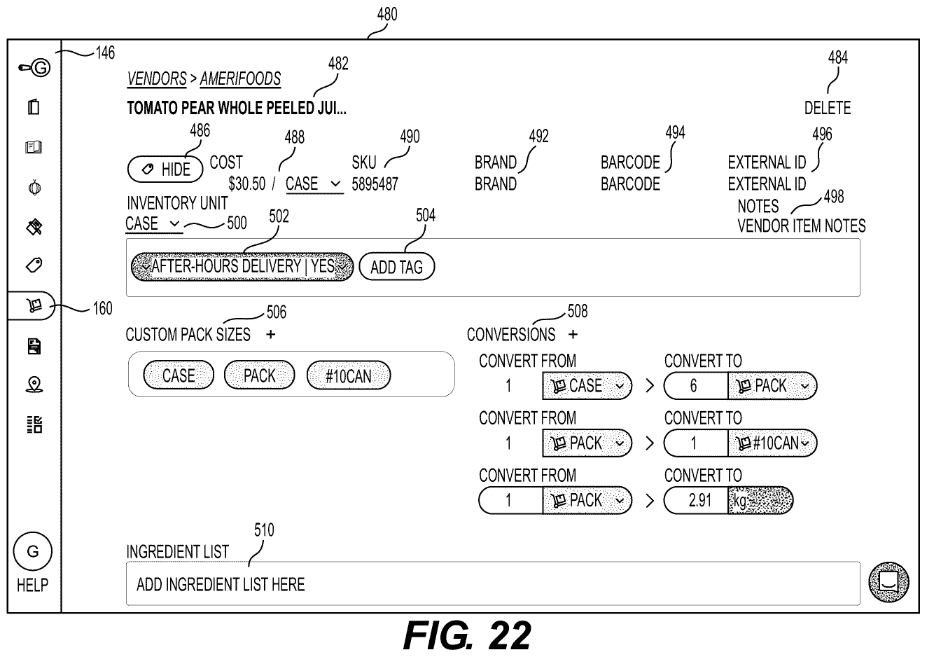

Clicking the add vendor item button 456 navigates the user to a vendor item creation page that includes unpopulated editable fields and sections of a vendor item page such as an example vendor item page 480 illustrated in FIG. 22.

Typing text into the search field 462 hides rows of the vendor-specific item table 466 not associated with the search field text.

Text in the “NAME” column of the vendor-specific item table 466 is clickable to navigate the user to the respective vendor item page. Fields in the “COST”, “SKU”, “BARCODE”, and “INVENTORY UNIT” columns are editable. Editing a field in the vendor-specific item table 466 automatically updates the corresponding field on the respective vendor item page.

FIG. 20 illustrates an example vendor item browser page 468. The vendor item browser page includes an edit columns button 469 and a vendor items table 470. The edit columns button 469, when clicked displays a clickable drop-down menu of optional columns that can be added to the all vendor items table 470. Optional columns available to the vendor items table 470 include categories having an item type of vendor item. In the illustrated example, in FIG. 16, the category “pricing priority” has an item type of “vendorItem”, and the edit columns button 469 on the example vendor item browser page 468 illustrated in FIG. 20, when clicked, displays a drop-down menu including “pricing priority” as an optional column that can be added to the all vendor items table 470. Categories are explained in greater detail in relation to FIGS. 16 and 17.

Names in the “NAME” column of the all vendor items table 470 are clickable to navigate the user to the respective vendor item page. The “ASSOCIATED INGREDIENT” column represents an association between an ingredient listed in a recipe and a vendor item. The same ingredient can be linked to multiple vendor items. For instance, the “avocado” ingredient listed under the “ASSOCIATED INGREDIENT” column of the all vendor items table 470 is the same ingredient, however when an avocado is called for in a recipe, it can be sourced from two different vendors: AmeriFoods and BritFoods. Separate vendor items exist for avocados supplied by AmeriFoods and BritFoods, hence avocados are listed on two rows and associated with two vendor item pages. An association of a vendor item to an ingredient can be removed by clicking the “x” to the right of the ingredient in the “ASSOCIATED INGREDIENT” column. To add an association between of a vendor item to an ingredient, the user can enter text in a search field in the “ASSOCIATED INGREDIENT” column which causes a clickable drop-down menu of search results to appear. The search results include can include ingredients accessible from the user interface, e.g. ingredients in the ingredients table 310 on the ingredients browser page 298 illustrated in FIG. 10. The “VENDOR”, “SKU”, and “COST” columns are automatically populated based on data edited from the respective vendor item page.

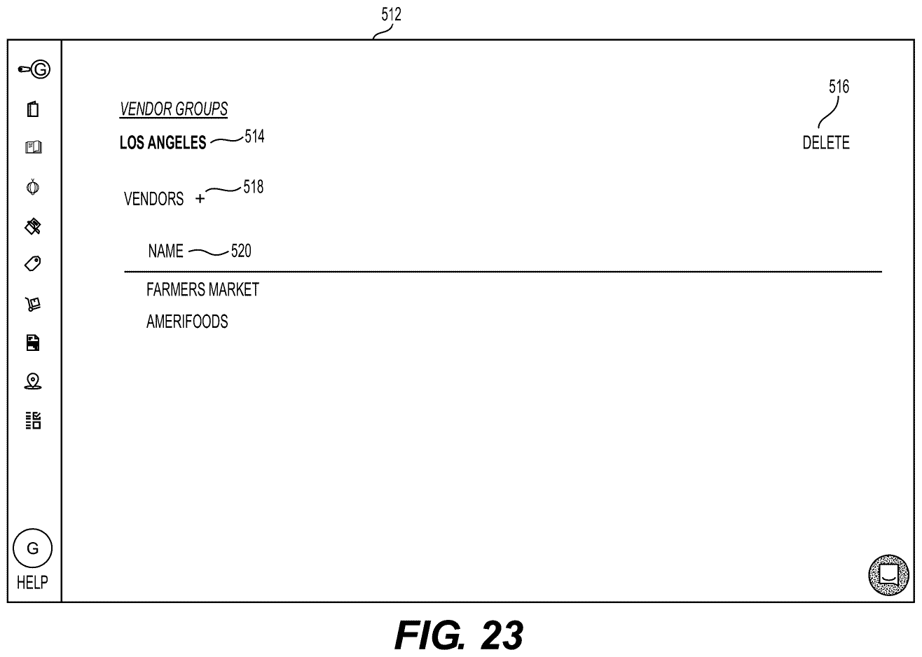

FIG. 21 illustrates an example vendor group editing page 472. The vendor group editing page 472 includes an add vendor group button 474, a view vendors button 476, and a vendor group table 478. The add vendor group button 474 navigates the user to a vendor group page (see FIG. 23) having unpopulated fields and inputs where the user can add a custom vendor group. The view vendors button 476 navigates the user to the vendor browser page 436 illustrated in FIG. 18. The vendor group table 478 includes a row for each vendor group. Rows in the vendor group table 478 are clickable to navigate the user to the respective vendor group page such as the example vendor group page 512 illustrated in FIG. 23.

FIG. 22 illustrates and example vendor item page 480. The vendor item page includes an editable name field 482, a delete button 484, a show/hide tags button 486, a cost per unit input 488, an SKU input 490, a brand input 492, a barcode input 494, an external ID input 496, a notes input 498, an inventory unit input 500, a custom pack sizes section 506, a custom conversions section 508, and an ingredients list input 510. When the show/hide tags button 486 is set to show tags, the vendor item page 480 further includes an add tag button 504, and when the vendor item is associated with a tag, the vendor item page 480 further includes a tag button 502.

The delete button 484 removes the vendor item from being accessible from the user interface and may or may not delete the vendor item from a vendor item database managed by the vendors module 124 of the system. Because pricing of ingredients, recipes, and menus is dependent on the cost of vendor items, deleting a vendor item can cause the cost of ingredients, recipes, and menus which utilize the vendor item to update. When an ingredient is associated with another vendor item from a vendor in the same vendor group (or otherwise viable vendor group) as the deleted vendor item, the system 100 can automatically update ingredients, recipes, and menus to perform calculations based on the viable undeleted vendor item. If there is no other viable vendor item for the ingredient, cost of ingredients, recipes, and menus are not calculated. For instance, in the ingredients cost table 292 of the recipe page 234 illustrated in FIG. 8D, if there is no viable vendor item associated with one of the ingredients listed, under the cost column, the message “Missing ingredient cost” or other indication may be shows to alert the user that no vendor item is associated with the ingredient. As a result, the total cost display 290 will not show a cost.

The show/hide tags button 486, when clicked, causes the tags 502 and add tag button 504 to be shown or hidden.

The cost input 488, SKU input 490, brand input 492, barcode input 494, external ID 496, notes input 498, and case inventory unit 500 are editable by the user so that the user can input the appropriate values specific to the item and the vendor.

The tag button 502 and add tag button 504 allow the user to associate the vendor item with a category and a category value. Clicking the left side of the tag 502 produces a drop-down menu that includes category names associated with the “vendorItem” item type as discussed in further detail in relation to FIGS. 16 and 17. Clicking the right side of the tag 502 produces a drop-down menu that includes category values associated with the selected category name as discussed in further detail in relation to FIGS. 16 and 17.

The custom pack sizes section 506 and the conversions section 508 function identically to the custom pack sizes section 388 and conversions section 390 in the vendor table 378 on the ingredient page 340 as illustrated in FIG. 13C. Updating the custom pack sizes section 506 and the conversions section 508 on the vendor item page 480 causes the respective custom pack sizes section 388 and/or conversions section 390 in the vendor table 378 on the ingredient page 340 to update automatically, and vice versa.

The ingredients list input 510 provides a text field input.

FIG. 23 illustrates an example vendor group page 512. The vendor group page includes an editable name field 514, a delete button 516, an add vendor button 518, and a vendor table 520.

The delete button 516, when clicked, removes the vendor group from being accessible from the user interface, but does not delete vendors within the deleted vendor group. Vendor groups are customizable by the user for the user's convenience. Deleting a vendor group may or may not affect links between a vendor item and a location as discussed in further detail in relation to the example location page 558 illustrated in FIG. 27. If the link between a vendor item and a location is broken, food cost of the ingredients associated with that vendor item will not be calculated or displayed in location-specific recipes and menus of that location.

The add vendors button 518 produces a drop-down menu with selectable items including a list of vendors not already present in the vendor table 520. The list of vendors can be viewed and searched form the vendor browser page 436. A vendor selected from the drop-down menu is added to the vendor table 520. Each vendor can be associated with one, multiple, or no vendor groups.

Each row in the vendor table 520 is clickable to navigate the user to the respective vendor page.

FIG. 24 illustrates an example purchase orders browser page 522. The purchase orders browser page includes an add purchase order button 524, a filters button 526, and a purchase orders table 528. The add purchase orders button 524 navigates the user to an unpopulated purchase order page where a user can create a purchase order. A new purchase order number is automatically generated for the created purchase order. Clicking the filters button 526 causes a pop-up window to appear which includes selectable filter criteria such as expected delivery date range (or option to include empty dates), status (open, archived, completed, cancelled, sent), vendors, location, other filter criteria, or any combination thereof. The purchase orders table 528 displays potentially useful information for each purchase order such as purchase order name, status, vendor, delivery date, destination location, and/or date modified. Each row of the purchase orders table 528 is clickable to navigate the user to the respective purchase order page.

FIG. 25 illustrates an example purchase order page 530. The purchase order page 530 includes a purchase order number display 532, status indicator 534, action button 536, vendor display 538, destination location 540, delivery date input 542, ingredient search field 544, total anticipated cost display 546, and a vendor item table 548. The purchase order number 532 is generated automatically when a new purchase order is created by clicking the add purchase order button 524 on the purchase orders browser page 522 illustrated in FIG. 24.

The status indicator 534 indicates the status of the purchase order, which can be open, sent, complete, cancelled, archived, or other such status. The actions button 536, when clicked, can cause a drop-down menu to be displayed from which a status can be selected and the option to delete the purchase order can be presented. Selecting a status from the drop-down menu from the actions button 536 causes the status indicator 534 to update to the selected status. The options available on the drop-down menu of the actions button 536 can change depending on the status indicated by the status indicator 534. For instance, when the status indicator 534 displays “open”, the drop-down menu of the actions button 536 can include the “sent” status as a clickable option, but not the “open” status. When the status indicator 534 displays “sent”, the drop-down menu of the actions button 536 can include add the “completed”, “cancelled”, and “open” statuses.

The vendor display 538 is editable from an unpopulated purchase order page and is locked from editing on an existing purchase order page. On an unpopulated purchase order page, the user can click the vendor display 538 and choose a vendor from a drop-down menu that appears. The destination location display 540 is editable from an unpopulated purchase order page and is locked from editing on an existing purchase order page. On an unpopulated purchase order page, the user can click the destination location display 540 and choose a vendor from a drop-down menu that appears. The delivery date input 542 is editable.

Items can be added to the vendor item table 548 by typing an ingredient name or vendor item name in to the ingredients search field 544 and selecting a vendor item from the drop-down menu that appears. The “INGREDIENT” and “ITEM” columns of the ingredients table 548 include clickable links to navigate the user to the respective ingredient page (see FIGS. 13A-D) or vendor time page (see FIG. 22). The “SKU column are automatically populated based on data entered in the vendor item page. The “QUANTITY” column of the ingredients table 548 includes inputs for selecting the quantity of each vendor item. The “ACPU” column is calculated based on the cost per one unit selected in the “QUANTITY” column and the cost of the vendor item as editable from the vendor item page. The units in the “QUANTITY” column need not match cost units on the vendor item page, and cost displayed in the “ACPU” column can be automatically calculated based on available unit conversions. The “TACPU” column is calculated based on the quantity selected in the “QUANTITY” column. The total anticipated cost display 546 displays a sum of the “TACPU” column.

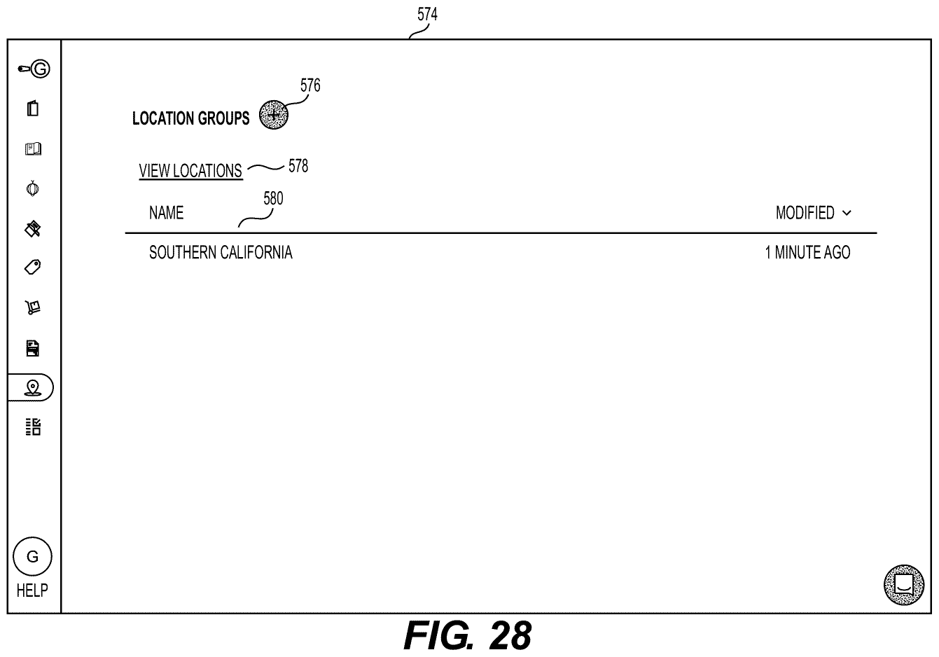

FIG. 26 illustrates an example location browser page 550 of the user interface of the system 100. The location browser page 550 includes an add location button 552, a view location groups button 554, and a location table 556. The add location button 552 navigates the user to an unpopulated location page in which the user can create a new location. The view location groups button 554 navigates the user to a location groups page 574 as illustrated in FIG. 28. The location table 556 displays a list of locations. Each row of the location table 556 is clickable to navigate the user to the respective location page such as the example location page 558 illustrated in FIG. 27.

FIG. 27 illustrates an example location page 558 of the user interface of the system 100. The location page 558 includes a location name field 560, a delete button 562, an address input section 564, an add vendor group button 566, and an add vendor button 570. If the location is associated with a vendor group, the location page 558 further includes one or more vendor group buttons 568. If the location is associated with a vendor, the location page 558 further includes one or more vendor buttons 572.

Costs of menus and recipes are calculated based on a selected location. Costs of ingredients within each recipe and menu are determined based on an association with a vendor item from a vendor associated with the selected location. If an ingredient in a menu or recipe is not associated with a vendor item from a vendor associated with the selected location, the cost of the menu or recipe cannot be calculated because the menu or recipe is missing a cost of that ingredient.

The delete button 562 removes the location from the user interface. Deleting the location from the user interface removes causes menus and recipes associated with the deleted location to become disassociated with any location and removes location-specific pricing of vendor items.

The address input section 564 can be utilized to input the address to which deliveries are to be received for a user's kitchen associated with the location. The delivery address associated with each purchase order is automatically populated based on the location set at the destination location display 540 of the purchase order page 530 (FIG. 25) and the address input in the address input section 564 of the location page 558.

The add vendor groups button 566, when clicked, displays a drop-down menu listing vendor groups not already associated with the location. Vendor groups associated with the location appear as vendor group buttons 568. Each vendor group button 568 is clickable to navigate the user to the respective vendor group page (see FIG. 23). Hovering over a vendor group button 568 causes an “x” to appear on the button that is clickable to remove the vendor group's association with the location.

The add vendor button 570, when clicked, displays a drop-down menu listing vendors not already associated with the location. Vendors associated with the location appear as vendor buttons 572. Each vendor button 572 is clickable to navigate the user to the respective vendor page (see FIGS. 19A and 19B). Hovering over a vendor button 572 causes an “x” to appear on the button that is clickable to remove the vendor's association with the location.

Removing a vendor group's association with a location effectively removes associations between the location and any vendors of the removed vendor group not separately associated with the location (i.e. the vendor does not appear as a vendor button 572). Removing a vendor's association with a location can cause menus and recipes associated with the location to have a missing ingredient price for ingredients associated with vendor items from the removed vendor. If an ingredient associated with the vendor item from the removed vendor is associated with an alternate vendor item from an alternate vendor associated with the location, the ingredient price can be calculated based on the alternate vendor item price.

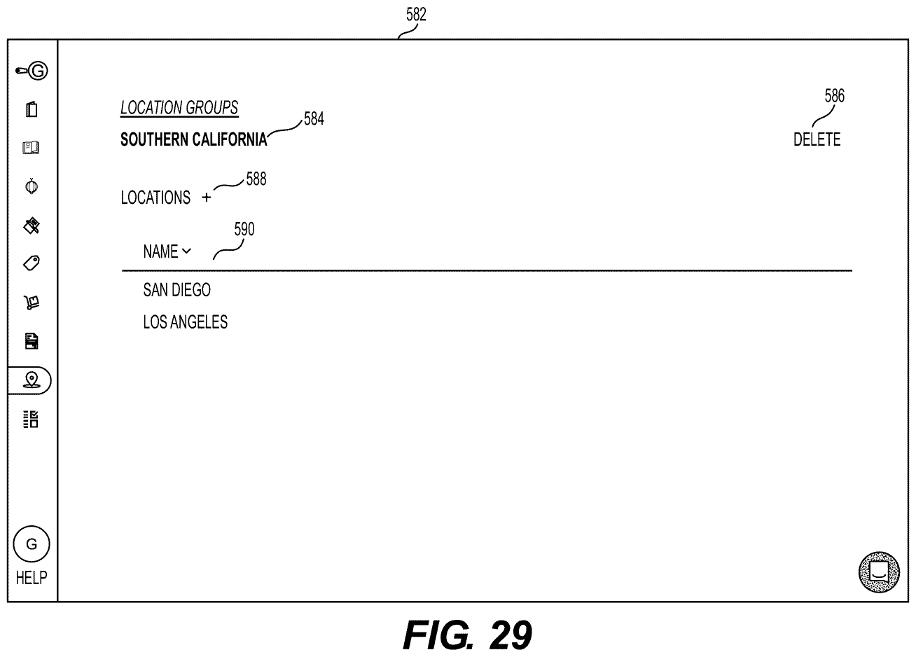

FIG. 28 is an illustration of an example location groups browser page 574 of the user interface of the system 100. The location groups browser page 574 includes an add location group button 576, a view locations button 578, and a vendor group table 580. The add location group button navigates the user to an unpopulated location group page (see FIG. 29). The view locations button 578 navigates the user to the locations browser page 550 illustrated in FIG. 26. The vendor group table 580 includes a list of vendor groups. Each row of the vendor group table 580 is clickable to navigate the user to the respective location group page (see FIG. 29).

FIG. 29 is an illustration of an example location group page 582. The example location group page includes an editable name field 584, a delete button 586, an add locations button 588, and a locations table 590. The delete button 586 deletes the location group but not the locations within the location group. The add locations button 588, when clicked, displays a drop-down menu listing locations not already in the locations table 590. Each row in the locations table 590 is clickable to navigate the user to the respective location page (see FIG. 27). Hovering over the row causes an “x” to appear next to the location name that that is clickable to remove the location from the location group.

FIG. 30 is an illustration of an example inventory record browser page 592 of the user interface of the system 100. The inventory record browser page 592 includes an add inventory record button 594, a filter button 596, and an inventory record table 598. The add inventories button 594 navigates the user to an inventory record creation page. On the inventory creation page, the user can type an inventory name, select an inventory template from a drop-down menu listing inventory templates, and generate an unpopulated inventory record page (see FIG. 31) based on the inventory template. Inventory templates can include freezer, refrigerator, produce, spices, bakery, dry goods, protein, specific vendor name, other food type designation, or any combination thereof. The filters button 596, when clicked, causes a pop-up window to appear within which the user can select filter criteria such as inventory date range, template name, location, status, other filter criteria, or any combination thereof. Inventory records appear in the inventory record table 598 according to the selected filter criteria. Each row of the inventory records table is clickable to navigate the user to the respective inventory record page (see FIG. 31).

FIG. 31 is an illustration of an example inventory record page 600 of the user interface of the system 100. The inventory record page 600 includes an inventory name display 602, an actions button 606, a location display 608, a date display 610, a search field 612, a group by button 614, a completed items display 616, an edit columns button 618, and an inventory tracking table 620. If the inventory record has not been submitted, the inventory record page 600 includes a submit button 604 and an add item button 613. If the inventory record has been submitted, the submit button 604 changes to a status indicator display indicating the inventory record is submitted and the add item button 613 disappears. Clicking the submit button 604 submits a previously unsubmitted inventory record.

The inventory name display 602 is not editable. The inventory name can be based on the template used to generate the inventory record. The illustrated example inventory page 600 is generated based on the dry goods template and therefore includes dry goods listed in the inventory tracking table 620.

The actions button 606, when clicked, displays a drop-down menu of actions that can be performed such as exporting the inventory list to a spreadsheet file, deleting the inventory record, or other action.

The location display 608 displays the location selected at the time the inventory record is created and is not editable thereafter. The date display 610 displays the date which the inventory record was created.

Text can be entered in the search field causes the inventory tracking table 620 to display only items having names including text in the search field.

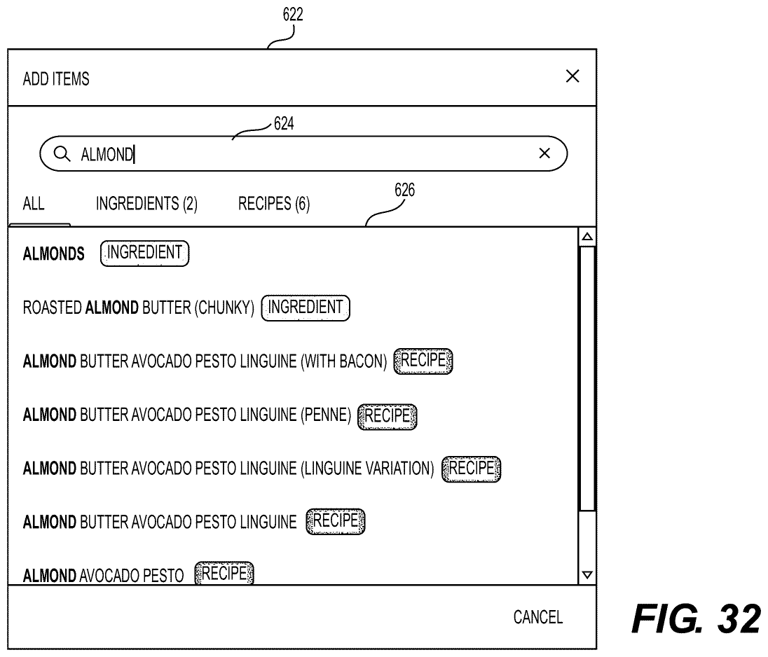

The add button 613, when clicked, causes an item search pop-up window 622 (FIG. 32) to appear. Inputting text in a search field 624 causes names of ingredients and/or recipes including the text to appear in a results pane 626. A user can click on a name in the results pane to add items to the inventory tracking table 620 on the inventory record page 600. Clicking an ingredient name adds that ingredient as a row to the inventory tracking table 620. Clicking a recipe adds all ingredients of that recipe to the inventory tracking table 620.

The group by button 614, when clicked displays a drop-down menu listing possible grouping schemes. The use can choose “none”, which displays all items in a single table 620 or a grouping scheme, which divides items among multiple tables which are selectable to be displayed in place of the inventory tracking table 620. An example grouping scheme can include the type of food good such as produce, protein, bakery, dry good, spice, refrigerator, freezer, etc. In such a grouping scheme, tabs for each group in which the items in the table are classified appear above the table 620. Clicking a tab displays, in the table 620, items classified into the group indicated by the clicked tab.

The completed items display 616 updates when quantities are entered in the “QUANTITY” column of the inventory tracking table 620. In the illustrated example inventory record page 600, all six items in the table 620 have a populated quantity.

The edit columns button 618, when clicked, displays a drop-down menu including optional columns that can be added to the table 620. The options in the drop-down menu of the edit columns button 618 can include grouping scheme names also displayed in the drop-down menu displayed by clicking the group by button 614.

The inventory tracking table 620 includes items added based on the template used when creating the inventory record page 600 and/or items added via the add button 613. Each inventory item is an ingredient in the ingredient database accessed by the ingredient catalog module 134. Quantities of each inventory item can be updated by editing the numeric quantity and unit of measurement under the “QUANTITY” column of the inventory tracking table 620.

FIG. 33 is an illustration of an example inventory creation page 648 that is automatically populated with ingredients from menus selected on the menus browser page illustrated in FIG. 3B. Clicking on the inventory query button 185 from the menus browser page 178 navigates the user to the inventory creation page 648 illustrated in FIG. 33. The inventory creation page 648 includes a menu selection indicator 650, an inventory category filter button 652, a create inventory button 654, and an inventory table 656. The menu selection indicator 650 indicates the number of menus upon which the prepopulated inventory table 656 is based. The inventory category filter button 652 causes category tags to appear. The user can then select a category name and category value. The categories can be provided by the user through the categories pages 416, 424 illustrated in FIGS. 16 and 17. The create button 654 navigates the user to an inventory page similar to the inventory page 600 illustrated in FIG. 31. The name 602, location 608, date 610, and inventory tracking table 620 can be populated based on menu information. Quantities of each ingredient in the inventory table 656 can prepopulated based on data in the inventory database.

FIGS. 34A and 34B are an illustration of an example purchasing page 658. The user can be navigated to the purchasing page 658 upon clicking the purchasing button 187 of the menus browser page 178 illustrated in FIG. 3B. The user can view the purchasing page 658 by scrolling down from the image illustrated in FIG. 34A to the image illustrated in FIG. 34B. The purchasing page 658 includes a create purchase orders button 660, an actions button 662, an order items clickable tab 664, a menus clickable tab 666, a recipes clickable tab 668, a category filters button 670, a menu locations drop-down list 672, a select inventories button 674, a location clickable tab 676, vendor selection buttons 678, vendor information bar 680, and vendor item table 682.

The create purchase orders button 660 generates purchase orders for each vendor having vendor items in the purchasing page 658. The create purchase orders button 660 further navigates the user to the purchase orders page 552 illustrated in FIG. 24.

The actions button 662, when clicked, displays a clickable drop-down menu including actions that can be performed on the purchasing page 658 including exporting the data on the page to a CSV file and printing ingredients.

The order items clickable tab 664, menus clickable tab 666, and recipes clickable tab 668 are each clickable to respectively cause a portion of the purchasing page 658 below the tabs 664, 666, 668 to display data related to the selected tab. FIGS. 34A and 34B illustrate the order items clickable tab 664 being selected. When the menus clickable tab 666 is clicked, the page 658 displays a list of menus upon which the purchasing page 658 is based. The list of menus includes menus selected on the menus browser page 178 illustrated in FIG. 3B when the purchasing button 187 is clicked. The recipes clickable tab 668, when clicked, causes a list of recipes to appear on the purchasing page 658. The list of recipes includes recipes used in the menus listed when the menus clickable tab 666 is selected.

The category filters button 670 causes a category tag to appear from which the user can select a category name and category value as described in relation to FIGS. 16 and 17. Selecting a category name and value causes the table 682 to only display vendor items associated with the selected category value.

The menu locations drop down list 672, which clicked displays a clickable drop-down menu from which the user can choose a shipping location for the vendor items. Selecting “All Menu Locations” causes the purchasing page 658 to rely on locations specified in each menu to determine the shipping location or locations.

The select inventories button 674, when clicked, displays a clickable drop-down menu including inventories present in the inventory database. When inventories are selected, and the create purchase orders button 660 is clicked, the purchase orders generated include quantities of ingredients to be used for the menus listed under the menus tab 666 that are not already present in the inventories selected by the select inventories button 674. In other words, selecting inventories with the select inventories button 674 will cause the system 100 to generate purchase orders that do not include ingredients that are already on hand in the selected inventories.

The location clickable tab 676 is clickable to view vendor and item data for each location when items are to be shipped to more than one menu location. Otherwise, the location clickable tab 676 is not clickable and shows the sole shipping location such as illustrated in FIGS. 34A and 34B.

The vendor selection buttons 678, when clicked, cause the vendor item table 682 to display items associated with that vendor. As illustrated, the vendor selection buttons 678 include an “unassigned” button, which, when clicked, displays ingredients in the table 682 that are not assigned to a vendor. Ingredients not assigned to a vendor are not included in the purchase orders generated when the create purchase orders button 660 is clicked.

The vendor information bar 680 displays information related to the vendor selected by the vendor selection buttons 678. The vendor name is clickable to navigate the user to the vendor page for that vendor (see FIGS. 19A and 19B).

The vendor item table 682 includes the name, number of recipe usages, quantity conversion calculation, and order amount of each vendor item associated with the vendor selected by the vendor selection buttons 678. The vendor item name is clickable to navigate the user to the ingredients page for the ingredient corresponding to the vendor item (see FIGS. 13A through 13D).

FIG. 35 is an illustration of a production list page 684. The user can be navigated to the production list page 684 by clicking the production planning button 189 on the menu browser page 178 illustrated in FIG. 3B. The production list page 684 includes a presets button 686, a selected menus table 688, an add category button 690, a category inheritance option button 692, a production list table 694, a print all button 696, and a round required button 698.

The presets button 686, when clicked, displays a clickable drop-down menu of options including a save as option. Selecting the save as option allows the user to save the production list as a preset production list. After the production list is saved, clicking the presets button 686 again gives the user the option of deleting the saved production list, or performing another save as function.

The selected menus table 688 includes a list of menus selected on the menus browser page 178 illustrated in FIG. 3B when the production planning button 189 is clicked. Names of the menus in the selected menus table 688 are clickable to navigate the user to the respective menu page (see FIGS. 5A through 5C).

The add category button 690 causes a tag with a selectable category name and category value to appear. Categories are discussed in greater detail in relation to FIGS. 16 and 17. Selecting a category and value causes the production list table 694 to display only recipes associated with the selected category value. Selecting a category and value can further cause a toggle button to appear which can allow the user to show recipes associated with the category value or recipes not associated with the category value.

The category inheritance option button 692 provides the option of associating sub-recipes to inherit category values from the parent recipes. As discussed in relation to the components table 282 of the recipe page 234 illustrated in FIG. 8B, recipes can include components, which are themselves recipes. The component recipes are sub-recipes, and the recipes which include the component recipe as a component is the parent recipe. Category values are discussed in greater detail in relation to FIGS. 16 and 17.

The production list table 694 includes recipes which meet the category value criteria and are included in the menus listed in the selected menus table 688. Names of each recipe are clickable to navigate the user to the associated recipe page (see FIGS. 8A through 8E). Quantities of each recipe in the production column of the production list table 694 are editable.

The print all button 696 navigates the user to a page where the recipes in the production list table 694 is digitally printed, for instance as a PDF file. From the printing page, the user can select units of measurements (e.g. imperial or metric) and the kind of unit (e.g. volume or weight). The printed recipes can include notes, instructions, components, and/or images.

The round required button 698, when clicked, resets the edited values in the production column of the production list table 694 to the required value in the required value column of the production list table 694.

FIG. 36 is an illustration of an example embodiment of the computing system 100. The system includes servers 628 or other suitable computing devices having one or more processors 638 and memory 634 having instructions thereon that when executed by the processor 638 causes the system 100 to provide some or all of the modules 102-142 illustrated in FIG. 1 (and/or otherwise described herein) and to further provide instructions that can be used by the user device 642 to display the user interface on the user device 642 such as illustrated in FIGS. 2 through 35. The servers 628 can have access to data provided by the vendor system 630 that includes data for vendor items such as cost data and/or quantities of units available for purchase (e.g. can, crate, pallet, etc.).

The term “computing system” is intended to include stand-alone machines or devices and/or a combination of machines, components, modules, systems, servers, processors, memory, detectors, user interfaces, computing device interfaces, network interfaces, hardware elements, software elements, firmware elements, and other computer-related units. By way of example, but not limitation, a computing system can include one or more of a general-purpose computer, a special-purpose computer, a processor, a portable electronic device, a portable electronic medical instrument, a stationary or semi-stationary electronic medical instrument, or other electronic data processing apparatus.

The term “database” as referred to herein is intended to include a collection of indexed data stored on a computer readable medium. The term “data store” as referred to herein is intended to include the computer readable medium on which the databases are stored. By way of example and not limitation, data in the database can include numerical values, textual values, computational representation of physical objects. Various data can be linked together or otherwise indexed. By way of example and not limitation, data in the database can be represented as an indexed matrix.

The term “dataset” as referred to herein is intended to include information that can be provided to a computing system in a computer readable format.

The terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

The term “non-transitory computer-readable media” includes, but is not limited to, random access memory (RAM), read-only memory (ROM), electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store computer readable information.

Certain embodiments and implementations of the disclosed technology are described above with reference to a block diagram of systems and/or computer program products according to example embodiments or implementations of the disclosed technology. It will be understood that one or more blocks of the block diagram, and combinations of blocks in the block diagrams can be implemented by computer-executable program instructions. Likewise, some blocks of the block diagrams may not necessarily need to be performed all of the functions described herein and may perform additional functions according to some embodiments or implementations of the disclosed technology.

1. A computer-implemented method for generating and managing menu and kitchen-related data, comprising:
receiving ingredient selections from a graphical user interface presented on a display device operatively coupled to at least one processor of an ingredients computing module of a kitchen computing system, the ingredients computing module comprising a memory storing an ingredients database in a structured data format and executable instructions that cause the processor to read from and write to the ingredients database, the ingredients computing module configured to build the ingredients database of preparations that can be used to associate with ingredients managed by the ingredients computing module;
displaying a recipe, from a recipes computing module of the kitchen computing system implemented by at least one processor executing instructions stored in memory and coupled to the ingredients computing module, based at least in part on the ingredient selections; the recipes computing module comprising a recipes database, and stored in the memory and accessible through the graphical user interface, the recipes computing module being configured to receive ingredient-related data and ingredients accessed from the ingredient computing module, present at least one selectable ingredient option on the graphical user interface, receive the at least one ingredient selectable option as user input events, generate one or more recipes based at least in part on the at least one selectable ingredient option, and write the recipe to the recipes database;
receiving one or more recipes selections and a recipe quantity for each of the one or more recipes selections via the graphical user interface;
displaying a menu, using at least the one or more recipes selections and a menu computing module of the kitchen computing system in communication with the recipes computing module and a menus database, the menu computing module being configured to receive recipe related data from the recipes computing module;
presenting at least one selectable menu option on the graphical user interface comprising one or more menus, menu items, recipes, ingredients, and items, receive one or more recipes selections and a recipe quantity via the graphical user interface, generate a menu based at least in part on the one or more recipes selections, and write the menu as a structured record to the menus database; and
executing, by the one or more processors, instructions to implement a costing computing module in communication with the menu computing module and a vendor item database stored in memory, the costing computing module including instructions that cause the one or more processors to receive the menu generated by the menu computing module, determine a cost per quantity of each ingredient selection of the menu based at least in part on a cost per vendor item of vendor items stored in the vendor item database, estimate a head count based at least in part on the recipe selections, the cost per quantity of each ingredient selection, and the recipe quantity for each recipe selection, and calculate a menu cost per head and store the menu cost in memory as a structured record associated with the menu, wherein the cost per quantity of each ingredient selection is location-specific and is determined based at least in part on an association between the ingredient selection and a vendor item from a vendor associated with a location selected via the graphical user interface, and a cost per vendor item, and display the calculated menu cost per head for the selected location.

2. A computer-implemented system for generating and managing menu and kitchen-related data, comprising:
one or more servers comprising one or more processors and non-transitory computer readable medium in communication with the one or more processors and having instructions that when executed by the one or more processors cause the computing system to provide a graphical user interface on a display device operatively coupled to the processors and a plurality of computing modules, the computing modules including each of:
an ingredients computing module in communication with an ingredients database and including instructions that, when executed by the one or more processors, cause the one or more processors to read from and write to the ingredients database, the ingredients computing module configured to build the ingredients database of preparations that can be used to associate with ingredients managed by the ingredients computing module;
a recipes computing module in communication with the ingredients computing module, a recipes database, and the graphical user interface, the recipes computing module including instructions that, when executed by the one or more processors, cause the one or more processors to receive ingredient-related data and ingredients accessed from the ingredient computing module; present at least one selectable ingredient option to the graphical user interface, receive the at least one ingredient selectable option from the graphical user interface, generate one or more recipes based at least in part on the at least one selectable ingredient option, and write the recipe to the recipes database; and
a menu planning module in communication with the recipes computing module and a menus database, the menu planning module including instructions that, when executed by the one or more processors, cause the one or more processors to
receive recipe related data from the recipes computing module;
present at least one selectable menu option to the user display comprising one or more menus, menu items, recipes, ingredients, and vendor items,
receive one or more recipes selections and a recipe quantity for each of the one or more recipes selections from the graphical user interface,
generate a menu based at least in part on the one or more recipes selections, and
write the menu to the menus database; and
a costing module in communication with the menu planning module and a vendor item database, the costing module including instructions that, when executed by the one or more processors, cause the one or more processors to receive the menu from the menu planning module; determine a cost per quantity of each ingredient selection of the menu based at least in part on a cost per vendor item of vendor items in the vendor item database; estimate a head count based at least in part on the recipe selections, the cost per quantity of each ingredient selection, and the recipe quantity for each recipe selection; calculate a menu cost per head; and display the calculated menu cost per head, wherein the cost per quantity of each ingredient selection is location-specific and is determined based at least in part on an association between the ingredient selection and a vendor item from a vendor associated with a location selected via the graphical user interface, and a cost per vendor item that is specific to the vendor item associated with the location, and display the calculated menu cost per head for the selected location.

3. The system of claim 2, wherein the menu planning module is configured to receive the recipe quantity for at least one of the recipe selections in a unit volume and/or unit weight.

4. The system of claim 3, wherein the unit of volume and/or unit of weight is a non-standard user-defined unit.

5. The system of claim 4, wherein the costing module is configured to receive, from user input of the graphical user interface, a unit name and a unit conversion of the non-standard user-defined unit, the unit conversion comprising a mathematical expression relating the non-standard user-defined unit to a standard unit of measurement.

6. The system of claim 2, wherein the computing modules further include a price computing module implemented by instructions stored in the memory and executed by the one or more processors, the price computing module being in communication with the vendor item database and the costing module, the price computing module configured to access cost data for vendor items stored as structured records in the vendor item database; and determine the cost per vendor item to the costing module for use in determining ingredient and menu costs.

7. The system of claim 2, further comprising a purchasing computing module implemented by instructions stored in the memory and executed by the one or more processors, the purchasing computing module being in communication with an inventory module, the menu planning module, and an inventory item database, the purchasing computing module configured to compare ingredient records and associated quantities stored in the inventory item database with ingredient and quantity data received from the menu planning module; and
generate a purchase order record based at least in part on comparing and store the purchase order record in the memory.

8. The system of claim 2, wherein the ingredients computing module includes instructions that, when executed by the one or more processors, cause the one or more processors to estimate a trim waste quantity for each ingredient managed by the ingredients computing module, the trim waste quantity being determined based at least in part on a preparation type associated with the ingredient.

9. The system of claim 2, wherein the costing module includes instructions that, when executed by the one or more processors, cause the one or more processors to calculate an untrimmed ingredient quantity by applying a trim waste quantity to a usage quantity of the ingredient within a recipe.

10. The system of claim 2, wherein the ingredients computing module is in communication with a dietary flags and nutritional analysis module configured to associate each ingredient maintained by the ingredients computing module with dietary and/or nutritional data.

11. The method of claim 1, further comprising:
estimating, using at least an ingredients computing module, a trim waste quantity for each ingredient managed by the ingredients computing module, the trim waste quantity being determined based at least in part on a preparation type associated with the ingredient.

12. The method of claim 11, further comprising: calculating, by the costing computing module, an untrimmed ingredient quantity by applying the trim waste quantity to a usage quantity of the ingredient within a recipe.

13. The method of claim 1, further comprising: determining, by a price computing module in communication with the vendor item database and the costing computing module, a cost per vendor item stored in the vendor item database to the costing computing module.

14. The method of claim 1, further comprising: receiving real-time vendor price data via a vendor integration module, and updating the vendor item database with the real-time vendor price data.

15. The method of claim 1, further comprising: receiving, by the costing computing module via the graphical user interface, a unit name and a unit conversion of a non-standard, user-defined unit, the unit conversion comprising a mathematical expression relating the non-standard, user-defined unit to a standard unit of measurement.

16. The method of claim 15, further comprising: storing the unit conversion in memory for use in calculating menu and recipe costs.

17. The system of claim 2, further comprising:
associating, by a dietary flags and nutritional analysis module in communication with the ingredients computing module, each ingredient maintained by the ingredients computing module with dietary and/or nutritional data.

18. The system of claim 2, wherein the costing module further includes instructions that, when executed by the one or more processors, cause the one or more processors to automatically recalculate the cost per quantity of each ingredient selection and the menu cost per head upon a change in the cost per vendor item in the vendor item database, without requiring additional user input.

19. The system of claim 2, wherein, upon removal of an association between a vendor item and a vendor associated with a location, the costing module further includes instructions that, when executed by the one or more processors, cause the one or more processors to determine whether an alternate vendor item from an alternate vendor associated with the location is associated with the same ingredient, and, if the alternate vendor item exists, automatically recalculate the cost per quantity of the ingredient selection and the menu cost per head based at least in part on a cost per vendor item of the alternate vendor item.

20. The method of claim 1, further comprising: automatically recalculating, by the costing computing module, the menu cost per head when a different location is selected via the graphical user interface, based at least in part on a different association between the ingredient selections and vendor items from vendors associated with the different location.
